(19) United States
(12) Patent Application Publication
(10) Pub. No.: US 2013/0317755 A1
(43) Pub. Date: Nov. 28, 2013

(54) Methods, computer-accessible medium, and systems for score-driven whole-genome shotgun sequence assembly

(71) Applicant: New York University, New York, NY (US)

(72) Inventors: Bhubaneswar Mishra, Great Neck, NY (US); Andreas Witzel, New York, NY (US); Fabian Menges, New York, NY (US); Giuseppe Narzisi, New York, NY (US)

(73) Assignee: New York University, New York, NY (US)

(21) Appl. No.: 13/986,485

(22) Filed: May 6, 2013

Related U.S. Application Data
(60) Provisional application No. 61/642,862, filed on May 4, 2012.

(51) Int. Cl. G06F 19/22

(52) U.S. Cl. CPC G06F 19/22
USPC 702/20

(57) ABSTRACT

Exemplary systems, methods and computer-accessible mediums for assembling at least one haplotype or genotype sequence of at least one genome can be provided, which can include, obtaining a plurality of randomly located sequence reads, incrementally generating overlap relations between the randomly located sequence reads using a plurality of overlapper procedures, and generating a layout of some of the randomly located short sequence reads based on a function in combination with constraints based on information associated with the one genome while substantially satisfying the constraints. The score-function can be derived from overlap relations between the randomly located short sequence reads. A search can be performed together with score- and constraint-dependent pruning to determine the layout substantially satisfying the constraints. A part of the genome wide haplotype sequence or the genotype sequence of the genome can be generated based on the overlap relations and the randomly located sequence reads.

### CROSS-REFERENCE TO RELATED APPLICATIONS

This application relates to and claims priority from U.S. Patent Application No. 61/642,862 filed on May 4, 2012, the entire disclosure of which is incorporated herein by reference.

### STATEMENT REGARDING FEDERALLY SPONSORED RESEARCH

The present disclosure was developed, at least in part, using Government support under Contract No. 1 R21HG003714-01 awarded by the NHGRI of National Institutes of Health. Therefore, the Federal Government may have certain rights in the invention.

### FIELD OF THE DISCLOSURE

Exemplary embodiments of the present disclosure relate generally to assembling genomes, and more specifically, to methods, computer-accessible mediums, and systems for haplotypic and/or genotypic genome sequences.

### BACKGROUND INFORMATION

If it were possible to be reasonably assured of the correctness/accuracy of the assembly of a reference genotype sequence, that a polymorphisms can be relatively rare and uniformly distributed, and that population genetics can have very few admixtures of separate ancestries, it could suffice to merely generate massive amounts of short reads that could be aligned to a reference sequence, thus enabling a relatively simple technology to study any individual's genomic make-up. In the absence of a genuine confidence in these underlying assumptions, however, there appears to be a need for technologies that can be coupled to, for example, computational procedures, etc., to assemble whole genome haplotypic sequences with an acceptable level of accuracy. Developing technologies combining optical mapping, hybridization data obtained with Peptide Nucleic Acids (“PNA”)/Locked Nucleic Acids (“LNA”) probes and procedures to solve local positional sequencing-by-hybridization (“PSBH”) problem can indicate one possible approach to this problem. However, the procedures at the core of this sequence-by-hybridization (“SBH”) technology are incapable of exploiting many other advances in sequencing technologies that focus on producing non-contextual short-sequence-read data.

Currently available technologies do not achieve the objectives of a scalable whole-genome haplotypic sequencer. For example, such conventional technologies generally generate relatively short genotypic reads (e.g., 30 bp-300 bp, without haplotypic and locational context); they generally can be corrupted by errors, such as low-quality base-calls or compression of homopolymeric runs, and they frequently lack long-range contextual information, except what can be available through a limited amount of mate-pair data. These shortcomings in the currently available technologies generally affect the yield, speed of the resulting technology, and can have a debilitating effect on the complexity of the assembly procedure.

To meet the current challenges of long-range haplotypic sequencing, there is a need for a technology design principle that does not just focus on base-by-base reads, but also takes into account the tractability of the procedures that can be used to handle the resulting data. Otherwise, the cost improvement and throughput gain at the single-base level could be squandered at the whole-genome level. Sequencing technologies can usually be thought of in terms of the two extremes: at one extreme can be technologies such as Sanger sequencing, which works by producing a correct index for every base, but can extend over a short range. At the other extreme can be technologies such as nanopore-based sequencers that aim for potentially long reads, but generally lack location information. There can be a large design space between these two extremes, in which the trade-offs between read-sizes and accuracy in locational information can be explored and/or evaluated.

Recent advances in genomic sciences have created new opportunities for identifying many of the genes commonly implicated in diseases, and elucidating many of the cellular pathways upon which they act. Ultimately, these advances can be expected to pave the way for a new science of individualized medicine, where the population based association studies can lead to immediately customizable and target therapies for specific diseases in specific individuals, for example. The underlying advances have generally come from three independent sources: (1) New Generation Sequencing (“NGS”) Technologies that can generate a massive amount of short reads covering a whole genome many times, (2) Ultra-High-Coverage Single Molecule Mapping (“SMM”) Technologies (e.g., Optical Mapping or AFM Mapping) that can provide whole-genome-wide long-range contextual information, and (3) Large-scale Population-wide polymorphism studies of Structural Variations (“SVs”) among genomes.

Recently, there have appeared many new ideas and approaches for generating short sequence reads from genomes relatively quickly, cheaply and in extensive amounts. For example, the classical dideoxynucleotide termination DNA sequencing technology, introduced by Fred Sanger in 1977, and commonly known as “Sanger Sequencing” technology, had been routinely used for large-scale sequencing at least until very recently. (See e.g., Reference 12). Over the years, the technology has been streamlined with better latency and higher throughput through improved, parallel and rapid sorting of fragments using capillary gel electrophoresis, thus addressing some of the inherent limitations posed by Joule-heating during fragment separation using slab gels. Despite these improvements, however, two predominant limitations have remained with such prior technology. First, the read-lengths cannot exceed about one Kb. Second, the reads have no associated contextual information (e.g., no chromosomal location or haplotypic disambiguation). Several new massively parallel sequencing methods have been proposed to address many of these issues; but, while most of these methods have provided lower latency and higher throughput at a lower cost, they have neither improved the read lengths, nor enabled addition of contextual information. For example, few representatives of these new classes of massively parallel short-read sequencing technologies are “Sequencing by Synthesis Pyrosequencing”. (See e.g., References 13 and 14). However, another technology's, goal (e.g., Pacific Biosciences') can be to create a technology that can read up to 5-75 Kb without increasing the cost. While such advancements can have a positive effect, Pacific Biosciences' technology, in isolation, generally can provide only limited improvement over other related technologies, as it lacks long-range information (e.g., information spanning over genomic regions of size 150 Kb or greater, or 100 Kb or greater).

Pyrosequencing can be a sequencing-by-synthesis technology. In pyrosequencing, upon nucleotide incorporation by the polymerase, the released pyrophosphate can be converted to Adenosine-5′-triphosphate (“ATP”) by action of the enzyme sulfurylase, with an energy source to convert luciferin to oxyluciferin and light. Because in sequencing by synthesis, during each cycle a single nucleotide species (e.g., A, T, C or G) can be used for querying, detection of the emitted light in each reaction cycle can provide the information as to which particular base, and possibly how many, can be incorporated in that reaction cycle. By combining the information from many successive cycles, it can be possible to read a large number of sequences in parallel. These sequencing technologies have found many applications: for example, serial analysis and gene expression (“SAGE”) profiling, cDNA sequencing, nucleasome positioning and metagenomics, but do not seem to be appropriate or cost-effective for population genomics, personal genomics or genomics-based individualized medicine, for example.

One embodiment of pyrosequencing can occur in the 454 GS-20 sequencing instruments, for example. (See e.g., Reference 15). This instrument integrates and parallelizes the entire process—starting from library construction to sequence detection. For example, starting with a genomic library of 500 bp-long fragments, the ends of fragments can first be repaired, then ligated with 454-specific linkers, and finally, coupled to Sepharose beads with covalently linked complementary oligoes that can hybridize to the fragment library's ligated linkers. The bead/DNA complexes can be emulsified in oil suspension containing aqueous Polymerase chain reaction (“PCR”) reagents in order for PCR amplifications to occur for each library-fragment producing many identical PCR products, all attached to the same bead. Pyrosequencing reactions can then be carried out on these PCR products simultaneously, as long as sequence detections can be achieved reliably and synchronously. The pyrosequencing reactions can be carried out on the beads, once they can suitably be arrayed on a PicoTiterPlate (“PTP”) device with sensors (e.g., fused optical fibers) engineered on to them. At the end of the process, software can be used to deconvolve the optical data into about 400,000 sequencing reads of 250 bp reads (e.g., about 100 Mb in total) over 7 hours. However, the read-length can be relatively short (e.g., only 250 bps) and the 400,000 fragments can have no contextual information. In addition, since in each cycle there can be no unambiguous way of determining exactly how many bases can be incorporated, if the genomic fragment can have a run of a single nucleotide base, 454-instrument may not be able to tell the run length, and thus produce a compression of the homopolymeric run to a single base.

In order to circumvent the problem of compression of homopolymeric runs, it can be possible to employ a more complex reversible dye-terminator chemistry, as in the platform built by Solexa, Ltd., for example. Starting with a library of genomic fragments, which can then be linker ligated, they can be amplified in-situ following hybridization to complementary oligoes, covalently linked to a flow cell surface. The fragments can then be amplified into clusters of PCR products, denatured, annealed with sequencing primers, and then read by a sequencing-by-synthesis approach to detect the 3′-blocked fluorescent-labeled nucleotide incorporated in a reaction cycle. Using this approach, a Solexa instrument currently can read about 60 million sequences, each of read-length no larger than 50 bp. Similar to the other technologies, the read-lengths from this technology can be even shorter, and can have little or no contextual problem. Despite being able to read almost 1× coverage of a genotypic human genome in a single run, these reads can fail to assemble to give any meaningful information. Even in simple resequencing applications, lack of contextual information can pose serious difficulties in placing the short sequence reads in the reference sequence efficiently and correctly.

In addition to these technologies, there can be other technologies, such as (i) ligation-based sequencing (e.g., building on genotyping methods used in ligation-chain-reaction (“LCR”) and oligonucleotide ligation assay (“OLA”)), (ii) sequencing by hybridization. A variant called Single Molecule Approach to Sequencing by Hybridization (“SMASH”) can replace array-based hybridization with hybridization to single molecules that can then be queried on a surface, sequencing with zero-mode waveguide and nanopore sequencing approaches. (See e.g., References 16-22).

However, a massively large number of such non-contextual short-reads can only lend themselves to biological interpretations, and biomedical applications, when they can be assembled into contiguous overlapping sequences encompassing the information contained in each haploid chromosome. Given the limitations of the current biotechnology instruments, such interpretations have to be obtained indirectly through computational procedures. The resulting classes of procedures have come to be known as “shotgun assembler,” and have aimed only to provide draft-quality (e.g., 1 bp error on the average in 10 Kb) accuracy genotype sequence contigs that cover repeat-free regions in the genomes, and that align and phase with respect to a scaffold, but that remain oblivious to rearrangement/translocation and orientation/inversion error. Even though researchers have significantly improved the ability to create a large-coverage library of sequence reads relatively quickly and cheaply, counterintuitively, the resulting technology has not increased the value of the information obtained. This can be because most of these technologies produce shorter read-lengths, corrupt the data with different forms of base-read errors, and may not be amenable to assembly processes that can provide useful long-range information, for example.

There can be large numbers of shotgun assembly procedures that differ from each other in a subtle way, but roughly follow a general set of strategies. In general, it may not be difficult to see that if, hypothetically, the genomes could be idealized as completely random sequences, the assembly problem could be easily solved with a simple and efficient (e.g., with a polynomial expected time-complexity) procedure that can use the significant overlaps among the sequence reads to create an overlay, and then determine a consensus sequence by combining the bases that align positionally. On the other hand, for example, if the computed genome sequence can be desired to be the most parsimonious solution (e.g., the shortest) among all possible sequences containing all of the sequence reads, then it can suffice to compute the shortest common super-sequence of the sequence-reads, which, however, can require solving an NP-hard problem.

This dilemma can be solved by first computing a greedy solution by successively combining the inter-sequence-read-overlaps in a reasonably good order (e.g., always selecting the most significant overlap among all the unused overlaps), and then heuristically correcting regions of the overlay in some plausible manner, whenever possible. Regions that do not yield to these error-correction heuristics can be abandoned as irrecoverable, and shown as gaps. In this manner, these greedy procedures can trade computational complexity against loss of genotypic information, number of gaps separating contigs and accuracy of the assembly. The classical greedy shotgun assembly procedures can use a general procedure that include the following substeps: (1) Fragment readout: The sequence-reads from each fragment can be determined by an automatic base-calling software; (2) Trimming vector sequences: Part of the vector sequences that could have been included during the sequence read phase can be removed; (3) Trimming low-quality sequence: Often the raw sequence reads contain low-quality base-calls, which can confuse the estimation of the overlap significance, and introduce insurmountable difficulties for the greedy shotgun assembly procedures. The greedy shotgun assembly procedures can usually remove or mask the low-quality base-calls in order to improve the accuracy of their sequence assembly; (4) Fragment assembly: The shotgun sequence reads can be used greedily to generate an overlay of aligned fragments to create contigs; (5) Fragment validation: Correctness of each assembled contig can be assessed, either manually or by certain extraneous heuristics; (6) Scaffolding contigs: The computed contigs can be oriented, phased and ordered. Currently, the greedy shotgun assembly procedures can use the limited size/distance information that can be inferred from mate-pair data, prepared by reading both ends of clones; (7) Finishing: The gaps between adjacent contig pairs, together with their locations and sizes, can be inferred by the scaffolding step, and these gaps can be closed by targeted sequencing. (See e.g., Reference 23).

One of the important sub-steps in the general procedure described above can be the fourth step, for example, labeled as “Fragment Assembly.” The greedy shotgun-assembly procedures can generally employ the overlap-layout-consensus approach, which can include three steps: (a) identification of candidate overlaps, (b) fragment layout, and (3) consensus sequence generation from the layout. The first step can be achieved by a string pattern matching technique, which can generate possible overlaps between fragments. The second step, as implemented in currently available shotgun assemblers, can usually be greedy, but vary in subtle ways from implementation to implementation; namely, the simplest implementations can often be based on a very simple greedy approach that examines one overlap after another, and the most sophisticated ones can use some graph-based direct representation of the overlaps or indirect ones using k-mers in the sequence-reads that encode the maximal overlaps in a De Bruijn graph representation, followed by a greedy search of the graph after some initial pruning. Certain complications can occur as sequence-read-pairs are dealt with that contain one in the other, chimeric sequence reads, sequences that can contain low-quality base-calls or regions of vector sequences, or sequence reads originating from repetitive regions.

For example, in CAP3 sequence assemblers, the overlaps can be determined by an optimal local alignment procedure, and then evaluated with respect to, for example, five measures: (i) minimum length, (ii) minimum percent identity, (iii) minimum similarity score, (iv) differences between overlapped reads at high-quality base-calls, and (v) differences between the rate of error at the overlaps under consideration, relative to a global sequencing error estimates. (See e.g., References 24 and 25).

In CAP3, an initial layout of reads can be created by a greedy method using overlap scores in decreasing order. Assuming mate-pair information can be available, the quality of the current layout can be assessed by the paired reads and the inferred distances between them. Consequently, regions of a layout with large number (e.g., using extremal statistics) of unsatisfied mate-pair-constraints can be identified, and input to a procedure that can align unaligned pairs according to their distances, and can attempt to correct these regions by adding satisfiable mate-pairs and “breaking” unsatisfiable pairs, repetitively, as long as progress can be made. Finally, contigs can be ordered and linked with unsatisfied constraints, where corresponding mate-pairs link paired sequences in two adjacent contigs. Similar ideas also occur in TIGR and PHRAP assemblers, for example. (See e.g., References 27 and 28)

As an example of a graph-based approach, it can be possible to consider the Celera Whole Genome Assembler (“WGA”), which has been used to genotypically assemble whole genome shotgun (“WGS”) sequence-reads of many large eukaryotic genomes. (See e.g., References 28 and 29). Celera WGA first can construct a graph of approximate overlaps between every pair of WGS sequence-reads, followed by a step to partition the graph by assigning an orientation to each fragment (e.g. forward or reverse complement) through a branch-and-bound (“B&B”) search, and terminated by selecting a set of overlaps that induces a consistent layout of oriented sequence-reads and merging the resulting multiple sequence alignments into a consensus sequence. Celera WGA's procedure can only be employed to search for solutions of a relatively simpler sub-problem of orientation assignment. Importantly, their score function can be based on the overlap scores of pairs in two possible relative orientations (e.g. same or opposite orientation), and neither can include any non-local statistics or long-range information, nor can it be extended in any meaningful way to incorporate such information as it lacks structures of genomic sub-paths. Consequently, Celera WGA's B&B approach does not provide a significant performance improvement in practice, and forces them to adapt the implementations to a hybrid approach that mixes B&B steps with greedy steps.

For other instantiations of graph-based greedy approach to shotgun sequence assembly, it can be possible to consider the Arachne and EULER assemblers. (See e.g. References 31 and 32). Like Celera WGA assemblers, Arachne has also found applications in large-scale genome assembly projects, can suffer from various problematic features discussed earlier (e.g., potential misassembly of rearrangements, haplotypic ambiguities, etc.). Arachne proceeds through several steps: (a) Overlap detection and alignment: computed by identification of k-mers of length 24, merging of shared k-mers, extension of shared k-mers to alignment and a refinement to optimal alignment by dynamic programming, (b) Error correction (e.g. using a majority rule heuristics), (c) Alignment evaluation (e.g. by a penalty score that penalizes base-call discrepancies), (d) Identification of mate pairs (e.g. by successively combining two overlapping pairs and repeating an augmentation step), (e) Contig Assembly (e.g. by merging and extending sequence-reads until putative repeat boundaries can be encountered), (f) Detection of repeat contigs, (g) Scaffold Generation with supercontigs, and finally (h) Gap filling in supercontigs. EULER assemblers can sidestep direct use of “overlap-layout-consensus” approach, by creating a De Bruijn graphs out of (k−1)-suffixes and prefixes of k-mers, and by searching for Eulerian superpaths in the resulting De Bruijn graphs after some initial pruning. Thus, it can incorporate several heuristics to disentangle clusters of erroneous edges, which can confuse the procedure to explore incorrect superpaths, and can get it stuck with incorrect solutions, especially when the quality of base-calls falls below a certain threshold. EULER tries to circumvent these problems by an error-correction process, which may not always be foolproof. In addition, it also attempts to improve the accuracy of the procedure by a series of graph-transformation heuristics that coalesce or partition collections of superpaths. In certain variations (e.g., EULER-DB and EULER-SF), this procedure has been modified to exploit the information available through mate-pairs (e.g., by creating artificial paths or scaffolds, respectively). However, none of these procedures can use long-range information to, for example, score solutions, and none are flexible enough to adapt to other long-range data. They also do not, for example, seek to avoid rearrangement errors or haplotypic ambiguities.

Certain recent advances in the genomic sciences have aimed to compensate for the deficiencies of the short-range sequencing technologies, and have primarily come from mapping technologies that can include, for example, optical mapping and array-mapping techniques, and enable a broad and long-range view of the whole genomes. In addition, they have played a significant role in validating sequence assemblies that can be prone to massive amount of otherwise undetectable errors. (See e.g., References 32-38).

To some degree, it can be possible to argue that the paper of Aston-Mishra-Schwartz had recognized how, in principle, long-range information from optical maps could assist shotgun sequence assemblers in assembly, contig-phasing and error-correction. However, the key assumptions of that paper, namely, optical map assembly procedures can be presumed to scale to any genome size in the presence of any error process (e.g., optical chimerism), has not proven to hold in reality. Granted that at intermediate scale (e.g., bacteria sized genomes), optical mapping has been phenomenally successful in cost, throughput and accuracy, and that the Aston-Mishra-Schwartz strategies have worked reasonably well in those cases, myriads of problems arise as one attempts to apply the same strategies to eukaryote-sized genomes, or desires to distinguish haplotypes. For instance, there still is no eukaryotic example (e.g., human or plant) where whole-genome optical-map-assisted high-quality haplotypic sequence assembly has been achieved.

During an approximately decade-long effort directed at optical mapping, single molecule optical mapping technology was developed for clones in 1998, and for whole microbial genomes in. (See e.g., References 38 and 39). In particular, a genome wide ordered restriction map of a single nucleic acid molecule, for example, double stranded DNA, can be generated using optical mapping techniques, for example, fluorescent microscopy. (See e.g., Reference 40).

A person having an ordinary level of skill in the art should understand how to generate a genome wide restriction map. Briefly, uncloned DNA (e.g., DNA directly extracted from cells after lysis) can be randomly sheared into approximately 0.1-2 Mb pieces, and attached to a charged glass substrate, where the DNA can be cleaved with a restriction enzyme, then stained with a dye (e.g., a fluorescent dye). The restriction enzyme cleavage sites can appear as breakages in the DNA under for example, a fluorescent microscope. Using predefined techniques, the optical mapping of breakages can produce a genome wide restriction map.

Exemplary procedures can be used to generate genome wide genotype or haplotype maps from optical mapping data (e.g., optical mapping probe data and/or optical mapping restriction data) can be based on Bayesian/Maximum-Likelihood estimation. (See e.g., References 41 and 42). Recent exemplary procedures for generating haplotype maps from optical mapping data can extend the older procedures to handle a mixture hypothesis of pairs of maps for each chromosome, corresponding to the correct ordered restriction maps of the two parental chromosomes. (See e.g., Reference 43). In addition, International Publication No. WO 2008/112754, Mishra et al., September 2008, the entire disclosure of which is herein incorporated by reference, relates generally to methods, computer-accessible medium, and systems for generating genome wide probe maps, as well as use of genome wide probe maps, for example, in methods, computer-accessible medium, and systems for generating genome wide haplotype sequences that can be read at a pre-defined level of accuracy, for example.

Statistical modeling of the errors can be straightforward. However, a combinatorial version of the problem for finding a best map assembly can be theoretically computationally infeasible. For example, it can be NP-hard, and there can be no corresponding polynomial-time approximation scheme (“PTAS”). This theoretical high complexity can apply to both genotype and haplotype map assembly cases as well as to other related variants. (See e.g., References 44 and 45).

Such combinatorial results can suggest that any procedure used to find the best map assembly can utilize computational time that can be super-polynomial (e.g., exponential) with respect to the size of the input data (e.g. under a widely accepted hypothesis that P≠NP). However, by appropriate design of an experimental set-up, it can be demonstrated that one can constrain the problem to only polynomially feasible instances of a normally infeasible problem. (See e.g., Reference 46).

For example, it can be possible to partition the sets of possible input data into two groups: an “easy” group having sufficiently low error rates or sufficiently high data coverage to compensate for the error rates, where probabilistic polynomial time solutions to the problem can be possible; and a “hard” group for which no polynomial time solution can be known. Further, it can be relatively easy to classify a data set based on the amount of data and the error rates of the data. (See e.g., Reference 47). The exemplary transition between the two data types of data sets can be quite sharp, which can result in a “0-1” law for useable data. This insight and its prudent exploitation has been useful in using optical mapping techniques to reliably generate a genome wide haplotype map, and it can be useful in providing suitable long-range information that can be used to scale sequence assembly procedures to handle construction of haplotypic genome sequences, for example.

Although optical mapping methods can be used to construct genome wide ordered restriction maps of whole genomes, such methods have not been used to assist genome-wide shotgun assembly of short sequence reads from any independent sequencing technologies in order to generate haplotype sequences.

There also have been attempts to combine optical mapping with sequencing by in-situ sequencing of immobile restriction fragments via nick translation. (See, e.g., Reference 53). However, the problem of assembling such short sequence reads anchored to the restriction fragments can rely on exploiting the implicit locational information in the data, and thus can utilize first explicitly creating an ordered restriction optical map and then interpreting the short reads (e.g. positionally anchored) appropriately via a technology-specific Bayesian prior model, for example. However, this approach may not cure certain problems because compression of homopolymeric can run as well as optical chimerism.

With the stated successful completion of the human genome project (“HGP”), it has been generally assumed that with access to a reference human genome sequence, it can be easier to catalog individual genomic differences relative to the reference genome sequence, and that the remaining challenges will only be in terms of designing (a) inexpensive experimental setups targeting relatively few and manageably small regions of polymorphic sites (e.g., about 30,000 haplotype blocks each encompassing no more than about 10 haplotypes), and (b) efficient procedural solutions for interpreting massive amount of population-wide polymorphism data. However, several implicit assumptions and hitherto unknown facts appear to impede progress along this direction.

For example, (i) currently available reference genome sequences tend to primarily provide genotypic information and remain to be validated as to their suitability in representing humans in a universal manner, (ii) all possible categories of dominant polymorphisms and their distributions have not been satisfactorily cataloged, (iii) haplotype data from a population can only be collected in many non-contextual short-range fragments that provide no meaningful long-range structural information, and (iv) such short-range data have to be phased statistically from population-wide distributions and with an inferred (e.g. assumed) distributions of recombination sites, which can differ significantly from the reality, etc. Exacerbating these fundamental hurdles, there can be the added difficulty of dealing with highly intractable computational problems, which can arise from the need to interpret non-contextual short-range data from many individuals and many subpopulations (e.g. with unknown population stratification) relative to any genotypic reference sequence.

If a competing non-contextual short-range sequence read technology is used, the sequence reads to the reference genome can be mapped using a relatively efficient and accurate sequence alignment procedure, under the assumption that reads will contain small local polymorphisms, and can nearly be identical to their corresponding sequence in the reference genome. In practice, a low-coverage (e.g., 2 or 3×) sequencing project can be used to generate sufficient number of reads to characterize a very large number of positional variations on the target genome, for example. The entire approach can rest on the simplifying assumption that although the new generation sequencing technologies can be unsuitable for de novo genome sequencing, they can be adapted to genome resequencing. However, in this assumption, it remains unclear as to how haplotypic ambiguities and structural variations are to be handled satisfactorily.

For example, in studies based on a resequencing approach, it can be assumed that it may not be significant to ignore most of the different sequence variations that individuals carry and it suffices to concentrate the efforts on important common variations (e.g., ones carried by a large fraction of individuals in a population), as only these can likely be disease associated. Following this reasoning, it can be possible to first characterize all frequent genetic variations by short-range resequencing of a limited number of randomly selected individual from populations, and using this information from genome-wide genotyping to determine allelic types for any previously characterized variation sites in the target genomes. For example, this approach can be an important component of the HapMap Project, which can focus only on mapping all common single nucleotide polymorphisms (“SNPs”). (See e.g., References 48 and 49).

The HapMap project can be implemented in two phases. First, using the genomes of 269 individuals from different populations about a million SNPs can be mapped across the genome, and later augmented with an additional 4.6 million SNPs. Using population-wide correlations among the SNPs the sequences of SNP sites on the reference genomes can be segmented into a small number of combinations of alleles, with the consecutive segments assumed to be separated by recombination hotspots. The combinations can be referred to as haplotypes and the segments as haplotype block. (See e.g., Reference 50). The subsequent analyses on the population can be carried out using these inferred blocks, independent of any validity as to whether the individual actually physically carries such haplotypes in its genome. Furthermore, a problematic circularity can be inserted into the reasoning in this process as the population, which can be used for haplotype inference, can then be analyzed by the same haplotypes to understand population stratification, disease association, and selection processes acting on these genomes.

With these traditional technologies, even more troublesome can be the assumption that all sequence variations in the human genome can be single nucleotide mutations, which has been seriously questioned by the rather serendipitous detection of copy-number polymorphisms through array-comparative genomic hybridization (“CGH”) technologies. Initially, copy-number fluctuations in the genomic segments can be assumed a hallmark of cancer genomes and can be assumed to arise by somatic mutations and can be assumed to be so detrimental to the normal genomes that they may not be expected to vary in the germ-line genomes. However, the technology that revealed these polymorphisms, and is currently widely used to study these variations, namely array comparative genome hybridization (e.g. array-CGH), can be incapable of characterizing their exact long-range structural properties (e.g., involving chromosomal inversions, translocations, segmental deletions, segmental duplications, and large-scale aneuploidy) and can likely be of limited utility. Importantly, many of these copy-number variations likely cannot be detected, nor can they be positionally and haplotypically located by using any of the conventional short-range non-contextual shotgun sequencing technologies that are currently available.

Array-CGH technologies can hybridize two sets of differentially labeled genomic fragments, from two different individuals, to an array of DNA probes, and can determine the copy number differences in the two genomes from a ratio-metric measurement at each of these probe locations. The raw copy-number fluctuation data can be further corrected procedurally by segmenting the genomes into regions of equal copy-number variations, and focusing on the regions where copy-number differs from the expected diploid values.

In another approach, pairs of reads can be obtained from clones, such as fosmids, using a genomic library constructed from the target genome. These reads can then be mapped to the reference human genome using exemplary alignment procedures similar to the ones used in resequencing, and then they can be analyzed to detect putative breakpoints where copy-numbers can be likely to change abruptly from one value to another. While such paired-end sequencing approach can be used to identify limited amount of structural variations (e.g. in addition to copy-number variations), they can lack haplotypic disambiguation, and can fail when the long-range rearrangement events span much larger-regions than what can be spanned by the clone length (e.g., a translocation event that moves a segment from one chromosome into another without changing its copy-number).

In basic biological research, as well as various applied fields, such as diagnostics, biotechnology, forensic biology and biological systematics, progress can depend on an ability to sequence an arbitrarily long piece of DNA and/or detect a specific DNA sequence in an ensemble. In the recent past, DNA-sequencing capability has increased, mostly because of exponentially rapid advancement in the speed, throughput, read length, and cost associated with the underlying biotechnology. Currently, a multitude of basic technologies exist that compete with each other in terms of cost and throughput, although no single one distinguishes itself in terms of error rates and read lengths; two critical parameters that can impact the subsequent biological research and discovery significantly.

These existing technologies can rely on auxiliary information that can utilize specialized sample preparation (e.g., pooling, dilution, bar coding, etc.) or other low-resolution long-range information (e.g., mate pairs, strobed sequencing, optical maps, dilution mapping, etc.). Furthermore, these results can include a sequence assembly or resequencing, and can be validated as sufficiently accurate for the intended scientific purposes. Consequently, the assembly pipeline, and the set of procedures it comprises, can benefit from being smart, flexible, efficient, and scalable.

In various mathematical formulations of the sequence and physical-map assembly problem, it can be shown to be intractable, for example, unless a long-standing mathematical conjecture (e.g., P=NP) can be false, and there can be no efficient (e.g., worst-case polynomial time) procedure to solve the assembly problem. Faced with these issues, certain prior approaches to this problem traded off completeness (e.g., gaps, repeats and haplotypes) and correctness (e.g., rearrangements) for simplicity, scalability and procedural efficiency, for example, as in greedy procedures (e.g., PHRAP, CAP, TIGR, etc.). Certain improvements can be provided through graph-theoretic formulations (e.g., overlap-layout-consensus graphs, string graphs or De Bruijn graphs, etc.), but these still face the problem of intractability, for example, because of the connections to Hamiltonian and Eulerian (e.g., super) path problems, which therefore can be used to resort to simple heuristics.

Thus, there is a need for a relatively inexpensively priced (e.g., less than $1,000 and/or $800-$1,200) genome sequencing technology of acceptable accuracy (e.g., on the average, one base error in less than 10,000 bps and/or one base error in 8,000 bps-12,000 bps) and high-speed (e.g., complete processing time for sequencing of less than one day, and/or twelve to thirty-six hours). It can also be beneficial to be continuously improved upon and/or afford many simultaneous and/or successive increasingly and/or exponentially rapid improvements over the near and/or long-term (e.g., one month, six months, one year, five years, ten years, twenty-five years, fifty years, one-hundred years, etc.). To incorporate such features, any new technology should have the capability to handle single molecules, work with a few and/or even single cells, operate at a nano-scale resolution and a femto-second speed, and be agnostic and/or independent to some, most and/or all of the available and anticipated short-sequence-read technologies.

Thus, the exemplary technology according to an exemplary embodiment of the present disclosure can anticipate the benefits of working with a minute amount of material, avoid amplification, be non-invasive, asynchronous and non-real-time. The exemplary technology can consider and/or integrate, for example, ideas, methodologies and/or implementations from multiple disciplines with appropriate abstractions, modularity and hierarchy. For example, the exemplary technology can aim for optimal integration of multiple technologies, such as, computational, physical, and chemical, with more emphasis on the technologies enumerated earlier in this order. In addition, the integrated technology should be error resilient, achieving relatively high reliability outcomes from relatively low reliability source(s), and intelligently selecting parameters modulating various 0-1 laws that shape and influence the quality of the experimental outcomes. This exemplary technology can also overcome some or all of the difficulties described above that can undermine the reliability of population-wide genomic studies.

### SUMMARY OF EXEMPLARY EMBODIMENTS

One of the objects of various exemplary embodiments of the present disclosure can be to overcome the deficiencies commonly associated with the prior art as discussed above, and provide exemplary embodiments of the computer-accessible mediums, methods and systems for assembling mutually-aligned personalized genome wide maps and haplotype sequences by combining short-rage non-contextual sequence reads and long-range mate-pairs, dilution or optical mapping techniques.

With exemplary computer-accessible mediums, methods and systems according to certain exemplary embodiments of the present disclosure, it is possible to utilize and/or emphasize the power of Bayesian procedures in combining short-range high-accuracy sequence reads with longrage low-resolution information in order to assemble the reads to produce acceptably accurate haplotypic whole-genome sequences. The exemplary computer-accessible mediums, methods and systems can avoid the problems of hompolymeric run compression and optical chimerism, and provide a direct procedure for individual (e.g., personal) haplotype sequencing, and can have significant implications on the study of a population and in characterizing important polymorphisms.

The exemplary computer-accessible mediums, methods and systems according to certain exemplary embodiments of the present disclosure can promote an exemplary approach that can lead to an exhaustive search over all possible overlays, but still tame the computational complexity through a constrained search as it can identify implausible overlays quickly through a score-function. Such exemplary score function can be, for example, based on statistical properties of the sequencing technology, errors in the sequence reads and genome structure, or based on side-information provided by the long-range mapping information.

The exemplary computer-accessible mediums, methods and systems according to exemplary embodiments of the present disclosure can focus on every individual in a population one at a time and reconstruct their haplotypic genome sequences accurately without any reference to any other genome sequence(s) from another and/or many other individual(s) from the population.

Exemplary embodiments of the present disclosure can facilitate an acceleration, improvement and scalability of the genome procedures for such exemplary purposes described above, for example, building on top of an existing sequencing pipeline, which can include TotalRecaller-SUTTA-FRCValidator. Many of the exemplary features of exemplary embodiments of the present disclosure can utilize Bayesian or empirical Bayesian approaches, and can be coupled to efficient B&B implementations. According to certain exemplary embodiments of the present disclosure, it can be possible to rely on two approaches to overcome the previously discussed impasse: (a) by recognizing that with suitable experiment designs (e.g., controlling error rates, coverage, read-lengths) it can be possible to generate “easy instances of a hard problem” (e.g., 0-1 Laws), and (b) by employing smarter score functions (e.g., obtained from dilution or optical maps) that could be exploited in an exhaustive search through B&B. It can be possible that in either case, the achievable correctness can be sacrificed for efficiency or scalability. The resulting exemplary approach can also be technology-agnostic, and can exclude any requirement to change the basic procedures with every change to the technology.

Described herein can be an exemplary embodiment of computer-accessible medium having stored thereon computer executable instructions for assembling haplotype sequence(s) of genome(s). For example, when the executable instructions can be executed by a processing arrangement, the processing arrangement can be configured to perform a procedure including, for example, obtaining a plurality of randomly located short sequence reads, using score function(s) in combination with constraints based on long range information associated with the genome(s), generating a layout of all of or a subset of randomly located short sequence reads such that the generated layout can be globally optimal with respect to the score function(s) while substantially satisfying the constraints, wherein the score function(s) can be derived from short-range overlap relations among the randomly located short sequence reads, searching coupled with score and constraint dependent pruning to determine the globally optimal layout substantially satisfying the constraints, and generating a whole and/or a part of at genome wide haplotype sequence(s) or genotype sequence(s) of the genome(s), converting globally optimal layout substantially satisfying the constraints into one or more consensus sequences, for example.

An exemplary processing arrangement in accordance with the present disclosure can be provided which can be configured to incrementally create the overlap relations window-by-window. In certain exemplary embodiments of the present disclosure, the data structure used to create the overlap relations can be prefix trees, Burrows-Wheeler transforms, hashing, or sorting. In addition, an exemplary processing arrangement in accordance with the present disclosure can be configured to create multiple contigs by following different paths; and organize contigs in order based on organizing score(s). The exemplary processing arrangement in accordance with the present disclosure can also be configured to score the multiple contigs with score function(s), which can include PCR, microarray, dilution, optical maps, and/or independent reads.

An exemplary processing arrangement in accordance with the present disclosure can be configured to obtain the randomly located short sequence reads using Sanger chemistry, sequencing-by-synthesis, sequencing-by-hybridization and/or sequencing-by-ligation. The exemplary processing arrangement can also be configured to obtain data including randomly located short sequence reads using method(s) having type(s) of error source(s), which, for example, can be incorrect base-calls, missing bases, inserted bases and/or homopolymeric compression. The genome(s) can include genomes from a plurality of diseased cells and/or non-diseased cells, individual organism(s), population(s), or ecological system(s), for example. The particular information can include long-range information and the randomly located non-contextual sequence reads can be aided by a score-function encoding particular long-range information. The long-range information can be obtained from one of a plurality of diseased and/or non-diseased cells, an individual organism(s), a population(s), or anecological system(s), for example. The exemplary long-range information also can be obtained from, for example, a mathematical model, existing data, genomic single-molecules, and/or genomic materials amplified and/or modified in a particular manner. The mathematical model can be Bayesian and/or empirical Bayesian.

The long-range information can be obtained from randomly sheared single molecules and/or targeted genomic single-molecules. The long-range information can be, for example, dilution information or a physical map that can be an ordered restriction map, a probe map, and/or a base-distribution map. The long-range information also can be obtained from amplified clones that can be analyzed by restriction activities and/or an end sequencing procedure. For example, according to certain exemplary embodiments, the long-range information can be obtained from existing data that can include (i) a reference haplotype or genotype whole-genome sequence, (ii) a reference collection of phased, unphased, haplotyped or genotyped sequence contigs, (iii) population-wide whole-genome sequences, and/or (iv) population-wide collections of phased, unphased, haplotyped or genotyped sequence-contigs.

The exemplary processing arrangement can be further configured to store the sequence reads in a tree-type of a data structure having paths that can be usable to organize possible arrangements of sequence reads. The sequence reads can be configured to be overlayed, while taking into account the overlaps, containments, and overhangs among consecutive sequence reads in an overlay along path(s) in the arrangement. The exemplary processing arrangement can be further configured to evaluate overlays along the path(s) by utilizing a score function. In addition, the exemplary processing arrangement can be further configured to use the score function to identify the path(s) having relatively low score values with respect to a rank order of the score values of all of the paths or plausible bounds. The exemplary processing arrangement also can be further configured to evaluate the score function with respect to the overlaps, containment and/or overhangs among a single pair and/or a local collection of pairs of the sequence reads.

In addition, the exemplary processing arrangement can be configured to evaluate the overlaps, containments or overhangs among the sequence reads with unknown orientations, locations, and haplotypic identities. The exemplary processing arrangement can be further configured to evaluate the overlaps, containments or overhangs, occurring among the sequence reads, from different sequencing technologies, with each different sequencing technology having a respective separate process for performing erroneous reads, for example. The exemplary processing arrangement can be further configured to determine thresholds below which the detected overlaps, containments or overhangs can be discarded from a further consideration. The exemplary processing arrangement can be configured to determine the values of at least one of the thresholds using a Bayesian method and/or an empirical Bayesian method, and can be further configured to determine the values of at least one of the thresholds using a procedure for controlling false discovery rates.

Further, the exemplary processing arrangement can be configured to evaluate the score function based on a consistency of the score function with respect to the particular long-range information. The exemplary processing arrangement can also be configured to evaluate the score function based on a consistency of the score function with respect to the particular long-range information by determining a local alignment with an alignment score, for example. The exemplary processing arrangement can be further configured to determine the score-function using a dynamic programming procedure for a local alignment with an alignment score. The exemplary processing arrangement can also be configured to determine the score function by using an alignment score parameter(s) obtained by, for example, a learning procedure, heuristics and/or a Bayesian-based design. Further, the exemplary processing arrangement can be configured to select one of the relatively best scoring arrangements of the sequence reads to determine a corresponding multiple sequence alignment that can be combined to generate the whole-genome haplotypic sequence(s).

The exemplary randomly located short sequence reads can be generated using Sanger chemistry, sequencing-by-synthesis, sequencing-by-hybridization and/or sequencing-by-ligation, for example. The exemplary randomly located short sequence reads can also be generated using a method having an error(s), which can be, for example, incorrect base-calls, missing bases, inserted bases and/or homopolymeric compression.

Another exemplary embodiment of a procedure according to the present disclosure can be provided for assembling haplotype sequence(s) of genome(s). The exemplary method can include, for example, obtaining a plurality of randomly located short sequence reads, using score function(s) in combination with constraints based on long range information associated with the genome(s), generating a layout of all of or a subset of randomly located short sequence reads such that the generated layout can be globally optimal with respect to the score function(s) while substantially satisfying the constraints. The score function(s) can be derived from short-range overlap relations among the randomly located short sequence reads, searching coupled with score and constraint dependent pruning to determine the globally optimal layout substantially satisfying the constraints, and generating whole and/or part(s) of genome wide haplotype sequence(s) or genotype sequence(s) of the genome(s), and converting globally optimal layout substantially satisfying the constraints into one or more consensus sequences, for example. An exemplary procedure according to the present disclosure can also include displaying and/or storing the particular information and/or a whole or one or more parts of genome wide haplotype sequence(s) in a storage arrangement in a user-accessible format and/or a user-readable format.

In addition, a system for assembling haplotype sequence(s) of a genome(s) according to another exemplary embodiment of the present disclosure can be provided. The exemplary system can include a processing arrangement, which, when executed, can be configured to perform a procedure(s) including: obtaining a plurality of randomly located short sequence reads, using score function(s) in combination with constraints based on long range information associated with the genome(s), generating a layout of all of or a subset of randomly located short sequence reads such that the generated layout can be globally optimal with respect to the score function(s) while substantially satisfying the constraints. The score function(s) can be derived from short-range overlap relations among the randomly located short sequence reads, searching coupled with score and constraint dependent pruning to determine the globally optimal layout substantially satisfying the constraints, and generating a whole and/or part(s) of genome wide haplotype sequence(s) or genotype sequence(s) of the genome(s). The globally optimal layout can be converted to substantially satisfy the constraints into one or more consensus sequences, for example.

These and other objects of the present invention can be achieved by provision of exemplary systems, methods and computer-accessible mediums for assembling at least one haplotype or genotype sequence of at least one genome can be provided, which can include, obtaining a plurality of randomly located sequence reads, incrementally generating overlap relations between the randomly located sequence reads using a plurality of overlapper procedures, and generating a layout of some of the randomly located short sequence reads based on a function in combination with constraints based on information associated with the one genome while substantially satisfying the constraints. The score-function can be derived from overlap relations between the randomly located short sequence reads. A search can be performed together with score- and constraint-dependent pruning to determine the layout substantially satisfying the constraints. A part of the genome wide haplotype sequence or the genotype sequence of the genome can be generated based on the overlap relations and the randomly located sequence reads.

The overlap relations can be incrementally provided in a window-by-window manner. The overlapper procedures can include a prefix tree, a Burrows-Wheeler transform, a hashing procedure, or a sorting procedure. The overlapper procedure can include the hashing procedure when a size of the randomly located sequence reads can be less than about 100 base pairs. The overlapper procedure can include the prefix tree when a size of the randomly located sequence reads can be greater than about 200 base pairs. The overlapper procedure can include the Burrows-Wheeler transform when an error rate in the haplotype sequence(s) or a genotype sequence(s) can be at or substantially near 0. The overlapper procedure can include the hashing procedure when an error rate in the haplotype(s) sequence or a genotype sequence(s) can be low.

In certain exemplary embodiments of the present disclosure, each of the randomly located sequence reads can be a seed, each of the seeds can have a forward direction which can include overlapping sequence reads in the forward direction and a backward direction which can include overlapping sequences in the backward direction. In some exemplary embodiments of the present disclosure, the multiple contigs can be produced by following different branches in the forward direction and the backward direction, each of the branches can represent an instance where multiple sequence reads overlap a single sequence read, and the contigs can be organized in order based on a predetermined organizing score. The at least one predetermined organizing score can be generated for the multiple contigs using a score function, which can includes PCR, microarray, dilution, optical maps, or independent reads.

In some exemplary embodiments of the present disclosure, the assembling of the forward direction or the backward direction can be parallelized by passing the assembling of the forward direction or the backward direction to a further processing arrangement. The assembling of the haplotype sequence or genotype sequence can be parallelized by passing a sequence read to a further processing arrangement. The processing arrangement can be further configured to communicate with the a further processing arrangement by passing information pertaining to the sequence reads to the further processing arrangement using asynchronous message queues. The information can include an estimated global position of a contig, relative position information or read information.

In certain exemplary embodiments of the present disclosure, the assembling of the branches can be parallelized by passing one of the branches to a further processing arrangement. In some exemplary embodiments of the present disclosure, each of the randomly located sequence reads can be a node, and one branch can be selected when at least two of the branches can converge at a single node, and prune further of the branches. The randomly located sequence reads can include randomly located short sequence reads, which can be less than about 100 base pairs. The information can include long-range information, which can include information that can be greater than about 150 Kb. The layout can be generated such that the layout is globally optimal with respect to the at least one score function. The overlap relations can include short-range overlap relations. A globally optimal layout can be converted into one or more consensus sequences so as to substantially satisfy the constraints.

These and other objects, features and advantages of the present disclosure will become apparent upon reading the following detailed description of exemplary embodiments of the invention, when taken in conjunction with the appended claims.

### BRIEF DESCRIPTION OF THE DRAWINGS

Further objects, features and advantages of the invention will become apparent from the following detailed description taken in conjunction with the accompanying figures showing illustrative embodiments of the invention, in which

FIG. 1A is an exemplary flow diagram of a method for generating at least one genome wide haplotypic sequence according to an exemplary embodiment of the present disclosure;

FIG. 1B is an exemplary flow diagram of a system which is configured to execute the exemplary method of FIG. 1A according to an exemplary embodiment of the present disclosure;

FIG. 2A is a representation of exemplary computer code for the high-level procedure according to an exemplary embodiment of the present disclosure;

FIG. 2B is a representation of the exemplary computer code for the node expansion procedure using the exemplary branch-and-bound method according to an exemplary embodiment of the present disclosure;

FIG. 3 is an illustration of an exemplary procedure for a contig construction associated with the exemplary procedure shown in FIG. 1A according to an exemplary embodiment of the present disclosure;

FIG. 4 is an example of a transitivity pruning procedure according to an exemplary embodiment of the present disclosure;

FIG. 5 is an illustration of an exemplary look-ahead procedure according to an exemplary embodiment of the present disclosure;

FIG. 6 is a graph of an example of a Brucella suis contig length distribution according to an exemplary embodiment of the present disclosure;

FIG. 7 is an illustration of an example of a Brucella suis big contig (e.g. 359.5 Kbp) according to an exemplary embodiment of the present disclosure;

FIG. 8 is an example of a table providing comparison of results of the exemplary procedure of the present disclosure and five other exemplary sequence assemblers;

FIG. 9 is an exemplary graph of an example of a Feature-Response curve for the Staphylococcus genome, comparing an example in accordance with the present disclosure and four other sequence assemblers when no mate-pairs are used in the assembly;

FIG. 10 is a graph of an example of a Feature-Response curve for the Staphylococcus genome, comparing an example in accordance with the present disclosure and other sequence assemblers when mate-pairs are used in the assembly;

FIG. 11A is an example of dot plot alignment of the Staphylococcus genome assembled according to an exemplary embodiment of the present disclosure;

FIG. 11B is an example of dot plot alignment of the Staphylococcus genome assembled by a previously-known assembler;

FIG. 12 is an exemplary diagram illustrating an exemplary overlapping procedure according to an exemplary embodiment of the present disclosure;

FIG. 13 is an exemplary diagram illustrating an exemplary multi-level parallelization procedure according to an exemplary embodiment of the present disclosure;

FIG. 14 is an exemplary graph of an exemplary optimization procedure according to an exemplary embodiment of the present disclosure; and

FIG. 15 is an illustration of an exemplary block diagram of an exemplary system in accordance with certain exemplary embodiments of the present disclosure.

Throughout the figures, the same reference numerals and characters, unless otherwise stated, are used to denote like features, elements, components or portions of the illustrated embodiments. Moreover, while the subject invention will now be described in detail with reference to the figures, it is done so in connection with the illustrative embodiments. It is intended that changes and modifications can be made to the described exemplary embodiments without departing from the true scope and spirit of the subject disclosure as defined by the appended claims (e.g., exemplary embodiments).

### DETAILED DESCRIPTION OF EXEMPLARY EMBODIMENTS

According to exemplary embodiments of the present disclosure, exemplary optical mapping procedures can be used to produce long-range information in the form of single-molecule-based ordered restriction maps. Such information, which, when analyzed in conjunction with short-range non-contextual sequence reads (e.g. arising, not exclusively, from a diverse group of new generation sequencing technologies), can be used to assemble the sequence reads correctly into a genome wide personalized haplotype sequence. Accordingly, described herein are exemplary embodiments of methods, computer-accessible mediums, and systems for assembling mutually aligned personalized genome wide maps and haplotype sequences using short-rage non-contextual sequence reads and long-range optical mapping techniques. These exemplary methods, computer-accessible medium, and systems can provide powerful strategies that can facilitate statistical combinations of disparate genomic information and/or exemplary chemical protocols that can, in parallel, manipulate and interrogate a large amount of sequencing, mapping and disease association data in various environments (e.g., personalized medicine, population studies, clinical studies, pharmacogenomics, etc.).

Exemplary embodiments of the methods, computer-accessible mediums, and systems, according to the present disclosure, can assemble short-range sequence reads with assistance from long-range low-resolution data. For example, genome wide optical maps can be provided for use in generating a genome wide haplotype sequence, (e.g., the nucleotide sequence of a whole diploid genome at the haplotypic level). Various exemplary applications of such exemplary methods, computer-accessible mediums, and systems can include, but are not limited to, analyzing patient genomes to predict susceptibility to various genetic or genomic diseases, analyzing patient genomes to diagnose genomic instability and mutations as the basis of cancer, analyzing patient genomes with or without other auxiliary data, to individualize therapeutic interventions for the patient, for example. Exemplary embodiments of the present disclosure can also have agricultural and biomedical applications in drug-or-vaccine discovery, understanding behavior of a cell in an altered state (e.g., cancer, neuron-degeneration, or autoimmune disease, etc.), genetically modifying a natural wildtype organism, genetic engineering, etc. Other exemplary applications can include, for example, understanding neural behavior, evolutionary processes, and genome evolution and aging.

As discussed herein, for example, advances in genomics, particularly in the development of new generation sequencing technologies and in the use of optical mapping to generate genome wide haplotypic long-range information via single-molecule restriction patterns, have created new opportunities for assembly procedures to create genome-wide haplotypic sequences. Such exemplary sequences can be used for locating common variants in polymorphisms, carrying out association studies, identifying many of the genes commonly implicated in diseases, and elucidating many of the cellular pathways upon which they act. In order to utilize these opportunities, exemplary embodiments of the present disclosure can provide robust, efficient, and inexpensive technologies, systems, procedures, and processes that can assemble short-range non-contextual sequence-reads into validated genome wide haplotype sequences, which can facilitate a review of genomic variations at multiple scales and across multiple individuals and species. Accordingly, described herein are exemplary embodiments of the methods, computer-accessible mediums, and systems, for assembling non-contextual sequence-reads into genome wide haplotype sequences.

The shotgun sequence assembling problem can generally be considered to be challenging for the following reasons: (1) in the absence of locational or contextual information and in the presence of low-quality base-call, the possible arrangements of overlay of all the sequence-reads can be likely and should be exhaustively considered, and (2) the shotgun sequence-reads can incorporate short-range information, and thus can be incapable of identifying which of these arrangements would be valid. If a “goodness” score can be defined for a particular arrangement of sequence reads, then the shotgun-sequence assembly problem can be formulated as a constrained global optimization problem, which can choose the “best” arrangement from, potentially a multitude of many possible arrangements of sequence-reads.

For example, if the “goodness” score can itself be defined in terms of validity of sub-arrangements, then it can be defined in terms of an empirical-Bayes or Bayes-like formulation, and the optimization of such a score function can provide a high level of confidence that the sequence reads can be assembled correctly. Such score function can be computed or determined in different ways, such as, for example, (i) by the significance of the overlaps selected in the assembly, (ii) by the significance of mate-pair constraints in the arrangements of the reads selected in the assembly, (iii) by the concurrence of the assembled consensus sequence with a reference sequence, and/or, (iv) by the agreement of the assembled consensus sequence with single-molecule restriction map (e.g. checked in terms of in silico computed restriction maps).

Such global optimization problems can likely be computationally intractable, and may not be able to be correctly solved by a “greedy” procedure, which can often be stuck in certain local maxima for the score function, and may not produce a valid sequence assembly.

Exemplary embodiments of the present disclosure can use a global search-method with B&B heuristics, or abeam search, to contain the complexity of the procedure. Such exemplary procedure can facilitate a location of the globally optimal solution and can achieve a high level of accuracy. To achieve a high computational space and time efficiency, the exemplary procedure can quickly prune out (e.g., identify and reject) branches leading to “unpromising” solutions (e.g., solutions for which there can be a relatively low level of expectation for success of achieving an acceptable level of accuracy). Additionally, such exemplary procedure can rely on the availability of sufficiently high coverage and good quality long-range genomic data (e.g., high coverage optical mapping data with good digestion rate and size accuracy). According to various exemplary embodiments of the present disclosure, the efficiency can use optical maps with respect to more than one enzyme.

In certain exemplary embodiments of the present disclosure, accuracy and validity of the assembled consensus sequence can rest upon the fidelity of the underlying models describing the “error processes,” involved in the long-range genome information and sequence reads, and reflected in the score. The exemplary score function can thus combine the Bayesian likelihood obtained from the prior distributions derived from the model and various penalty functions corresponding to various constrains, for example. In certain exemplary embodiments of the present disclosure, various relatively simple but meaningful heuristic score functions and penalty functions can be employed. These functions can be provided by a human, be learned from the data by any generally known “machine learning” approach, or by an empirical Bayes approach that can derive the priors from the data themselves. For example, an empirical-Bayes method can be used to decide the statistics and thresholds (e.g., null-model, threshold, p-values, base- or sequence-quality), thus making the system independent from the underlying technology while being able to mix-and-match different technologies.

According to further exemplary embodiments of the present disclosure, in addition to score functions based on certain modeled, learnt or known models, and/or other information can be used (e.g., optical maps, mated pairs, base-content, homologous reference sequences, etc.), which can sharpen and improve the score function causing the procedure to behave more efficiently.

An exemplary procedure according to the present disclosure can use differing technologies, including those for which no known models of error processes heretofore exist. For example, there can be two different kinds of sequence-reads with two different length parameters, from two different technologies, and subjected to two different classes of error processes. In this example, these two different technologies can be, for example, 454/Roche and Solexa/Illumina; 454 sequence reads can be of length 500 bp on the average and Solexa sequence reads, 50 bp; 454 can have homo-polymer compressions, while Solexa can have seriously low-quality base calls beyond a certain length, for example. From the data itself, however, it can be possible to create a null-model of false-overlaps, and these distributions can then be used in an exemplary score function.

A score-function in accordance with the present disclosure can be used to guide the manner in which the short-sequence reads can be arranged, and can be further combined into haplotype sequence information either in its entirety, or in parts, in terms of contigs.

For example, certain exemplary procedures that can be used to improve efficiency can be described as being of different types, for example: (i) careful selection of the experimental parameters used in collecting the long-range experimental data; and (ii) estimation of tight bounds on the statistically less significant score values, which can facilitate early and aggressive identification and rejection of unpromising regions/directions in sequence assembly. Thus, an exemplary procedure can be implemented to work quickly by dovetailing between local (e.g. short sequence-reads) and global (e.g. long-range maps and haplotypic) information. Such exemplary procedure can organize the sequence-read arrangements in a tree-type structure, which can be periodically trimmed to terminate the relatively low-scoring and unpromising directions, by using the long-range information in the score function to recognize those paths in the tree that can be inconsistent with the long-range information, for example. Since the tree can also organize the long-range information along the paths, errors that can be in the long-range information can automatically be discarded by this process. For example, if the long-range information used can be single-molecule optical maps, then while the optical maps can ensure that the assembly of the sequence-reads proceed along the correct directions, the assembled sequences can identify the incorrect single molecule maps (e.g., those with optical chimerism, quickly and force them to be discarded immediately).

Exemplary embodiments of procedures according to the present disclosure can be tuned heuristically (e.g., size of a priority queue used in the B&B) to obtain, for example, the best possible computational complexity and resource consumptions as a function of specific error parameters and accuracy. For example, this exemplary procedure can automatically provide a way to exploit underlying 0-1 laws in these technologies, such as, for example, a law that states that there can exist certain error parameter thresholds, for the error processes in sequencing and mapping, below which the probability of assembling sequence-reads correctly can be relatively close to zero, while above this threshold, the correct assembly probability can sharply jump to be relatively close to one. Such laws can have strong implications for the design of the underlying technologies, choice of the component technologies, parameters used in the technologies and in selecting the manner in which the exemplary procedure operates.

An exemplary procedure can parallelize in a straightforward manner, as multiple regions can be explored simultaneously by different processors, with search trees starting with roots at a relatively small number of randomly selected seeds (e.g. sequence-reads from which a local assembly can be initiated).

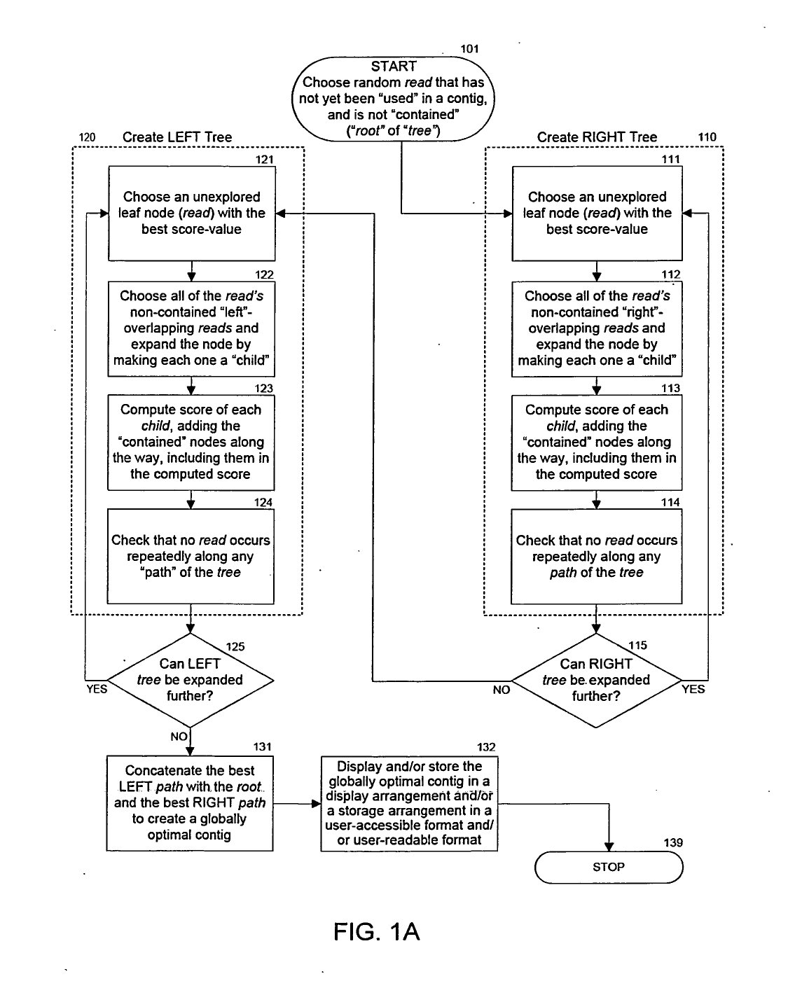

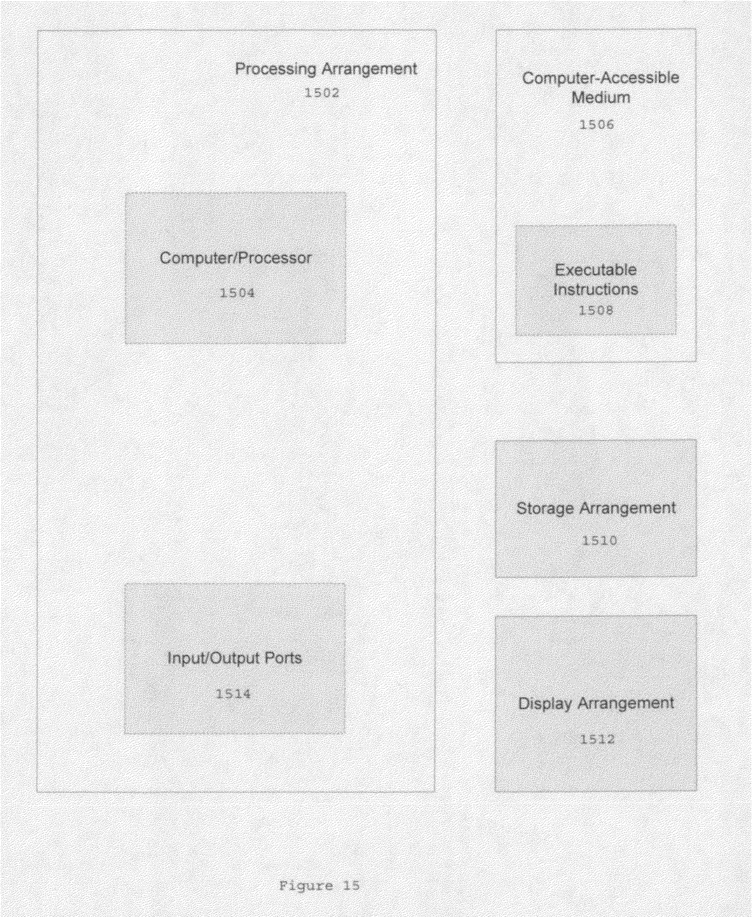

FIG. 1A shows an exemplary flow diagram of a method for generating at least one genome wide haplotypic sequence in accordance with an exemplary embodiment of the present disclosure, which can be implemented by the exemplary block diagram of FIG. 15.

This exemplary procedure can be performed by a processing arrangement 1502. For example, processing arrangement 1502 can be, entirely or a part of, or include, but not limited to, a computer that includes a microprocessor, and using instructions stored on a computer-accessible medium (e.g., RAM, ROM, hard drive, or other storage device).

In procedure 101, the processing arrangement 1502 can choose a random read that has not yet been “used” in a contig, and may not be “contained.” This read can be the root of a tree.

In procedure 111, the processing arrangement 1502 can start to generate the RIGHT tree (e.g. sub-procedure 110) by choosing an unexplored leaf node (e.g. read) with the best score-value. Next, in procedure 112, the processing arrangement 1502 can select most or all of the read's non-contained “right”-overlapping reads, and expand the node by making each one of them a child. In procedure 113, the processing arrangement 1502 can compute the scores of each child, adding the “contained” nodes along the way, while including them in each computed scores. The processing arrangement 1502, in procedure 114, can then check that no read occurs repeatedly along any path of the tree.

In procedure 115, the exemplary processing arrangement 1502 can inquire whether the RIGHT tree can be expanded further. If the answer determined by the exemplary processing arrangement 1502 in procedure 115 can be “yes”, then the exemplary procedure can return to procedure 111, in which the processing arrangement 1502 can continue to create the RIGHT tree (e.g. sub-procedure 110) by choosing an unexplored leaf node (e.g. read) with the best score-value. If the answer determined by the exemplary processing arrangement 1502 in procedure 115 can be “no”, then the exemplary procedure can proceed to procedure 121, in which the exemplary processing arrangement 1502 can begin to create the LEFT tree (e.g. exemplary sub-procedure 120) by choosing an unexplored leaf node (e.g. read) with the best score-value.

After selecting an unexplored leaf node (e.g. read) with the best score-value in procedure 121, the exemplary processing arrangement 1502, in procedure 122, can then choose all of the read's non-contained “left”-overlapping reads, and expand the node by making each one of them a child. In procedure 123, the exemplary processing arrangement 1502 can compute the scores of each child, adding the “contained” nodes along the way, while including them in each computed score. The exemplary processing arrangement 1502, in procedure 124, can then check that no read can occur repeatedly along any path of the tree.

Next, in procedure 125, the exemplary processing arrangement 1502 can inquire whether the LEFT tree can be expanded further. If the answer determined by the exemplary processing arrangement 1502 in procedure 125 can be “yes”, then the exemplary procedure can return to procedure 121, in which the exemplary processing arrangement 1502 can continue to create the LEFT tree (e.g. sub-procedure 120) by choosing an unexplored leaf node (e.g. read) with the best score-value. If the answer determined by the exemplary processing arrangement 1502 in procedure 125 can be “no”, the exemplary procedure can proceed to procedure 131, in which the exemplary processing arrangement 1502 can concatenate the best LEFT path with the root and the best RIGHT path to create a globally optimal contig. The exemplary procedure can then continue to procedure 132, in which the exemplary processing arrangement 1502 can display and/or store the globally optimal contig in a display arrangement 1512 and/or a storage arrangement 1510 in a user-accessible format and/or user-readable format. The exemplary procedure can then continue to procedure 139, in which it can be stopped by the processing arrangement 1502.

The exemplary processing arrangement 1502 can be provided with or include an input arrangement 1514, which can include, for example, a wired network, a wireless network, the interne, an intranet, a data collection probe, a sensor, etc. Further, the exemplary processing arrangement 1502 can be provided with or include an output arrangement 1514, which can include, for example, a wired network, a wireless network, the internet, an intranet, etc., in addition to a display arrangement and/or a storage arrangement in which data can be stored in a user-accessible format and/or user-readable format.

FIG. 1B shows a diagram of the exemplary procedure of FIG. 1A. As described above, this exemplary procedure can be performed by a processing arrangement 1502, which, for example, can be, entirely or a part of, or include, but not limited to, a computer that includes a microprocessor, and using instructions stored on a computer-accessible medium (e.g., RAM, ROM, hard drive, or other storage device).

A computer-accessible medium 1506 (e.g., as described herein above, storage device such as hard disk, floppy disk, memory stick, CD-ROM, RAM, ROM, etc., or a collection thereof) can be provided (e.g. in communication with the processing arrangement 1502). The computer-accessible medium 1506 can contain executable instructions 1508 thereon. In addition or alternatively, a storage arrangement 1510 can be provided as part of, or separately from,0 the computer-accessible medium 1506, which can provide the instructions to the processing arrangement 1502 so as to configure the processing arrangement to execute certain exemplary procedures, processes and methods, as described herein above.

For example, the exemplary processing arrangement 1502 can choose and/or receive a random read 152 choosing a random read that has not yet been “used” in a contig, and may not be “contained.” This read can be the root of a tree. In procedure 110, the processing arrangement 1502 can create the RIGHT tree. In procedure 115, similar to FIG. 1A, the exemplary processing arrangement 1502 can inquire whether the RIGHT tree can be expanded further. If the answer determined by the exemplary processing arrangement 120 in procedure 115 can be “yes”, then the exemplary procedure returns to procedure 110, in which the processing arrangement 1502 can continue to create the RIGHT tree. If the answer determined by the exemplary processing arrangement in procedure 115 can be “no”, then the exemplary procedure proceeds to procedure 120, in which the exemplary processing arrangement 1502 can create the LEFT tree by choosing an unexplored leaf node (e.g. read) with the best score-value, in a similar manner as provided above with respect to FIG. 1A.

In procedure 115, the exemplary processing arrangement 1502 can inquire whether the LEFT tree can be expanded further. If the answer determined by the exemplary processing arrangement 1502 in procedure 115 can be “yes”, then the exemplary procedure can return to procedure 120, in which the exemplary processing arrangement 1502 can continue to create the LEFT tree by choosing an unexplored leaf node (e.g. read) with the best score-value. If the answer determined by the exemplary processing arrangement 1502 in procedure 115 can be “no”, the exemplary procedure can proceed to procedure 131, in which the exemplary processing arrangement 1502 can concatenate the best LEFT path with the root and the best RIGHT path to create a globally optimal contig. The exemplary procedure then continues to procedure 132, in which the exemplary processing arrangement 1502 displays and/or stores the globally optimal contig in a display arrangement 1512 and/or a storage arrangement 1510 in a user-accessible format and/or user-readable format. The exemplary procedure can then proceed to procedure 139, in which it can be stopped by the processing arrangement 1502.

As described above, an exemplary procedure can use B&B (e.g. or beam search) to avoid immense space and time complexity. An exemplary procedure can also use depth-first search interval schemes to determine if a read can occur repeatedly along a path. Furthermore, it may only check right- or left-overlapping properties between two reads, while expanding the root, since checking just overlapping relation for the non-root node can be sufficient. It can be preferable to avoid reads from the best right path to be included in any left path. Thus, exemplary bookkeeping can be done to keep track of “used,” “explored,” “overlapping,” and “contained” relationships, for example.

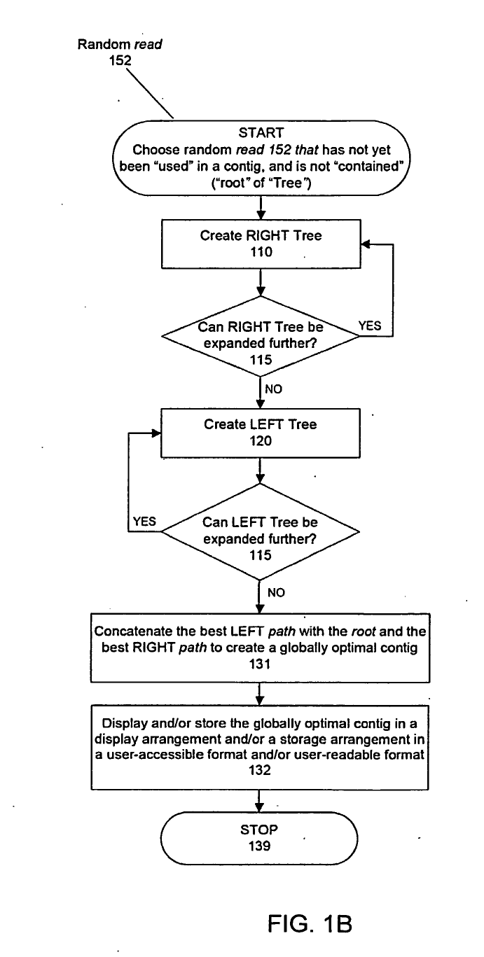

FIGS. 2A and 2B illustrate representations of exemplary computer executable instructions (e.g. computer code) for an exemplary procedure in accordance with certain exemplary embodiments of the present disclosure.

In particular, FIG. 2A illustrates an exemplary representation of exemplary computer code 210 for a high-level procedure 211 in accordance with an exemplary embodiment of the present disclosure. As shown in this example, two particular data structures can be maintained: (i) a forest of double-trees (e.g. D-tree) F 212 and (ii) a set of contigs C 213. Upon execution of each procedure 215, a new D-tree can be initiated from one of the remaining reads left in the set of available reads B 214. Once the construction of the D-tree can be completed, the associated contig can be created and stored in the set of contigs C 213. Next, the layout for this associated contig can be computed, and its reads can be removed from the set of available reads B 214. This exemplary process can continue as long as there can be reads left in the set of available reads B 214. According to certain exemplary embodiments of an exemplary process, both the forest of D-trees F 212 and the set of contigs C 213 can be kept and updated in the pseudocode. According to other exemplary embodiments of an exemplary process, however, after the layout of a contig can be computed, there can be no particular reason to keep the full D-tree stored in memory, especially, where, for example, there can be certain memory restrictions or requirements.

FIG. 2B illustrates an exemplary representation of exemplary computer code 220 for a node expansion procedure using an exemplary B&B procedure that can be used in the exemplary high-level procedure 211 of FIG. 2A. The amount of exploration and resource consumption (e.g. pruning) can be controlled by, for example, the two parameters K 212 and T 213, where K 212 can be the max number of candidate solutions allowed in the queue at each time step, and T 213 can be the percentage of top ranking solutions compared to the current optimum score. According to this example, at each iteration 214, the queue can be pruned such that its size can be ≦max(K, T). While K 212 can remain fixed at each iteration of the expansion routine, the percentage of top ranking solutions can dynamically change over time. Accordingly, more exploration can be performed when there can be many solutions to evaluate having a similar score, for example.

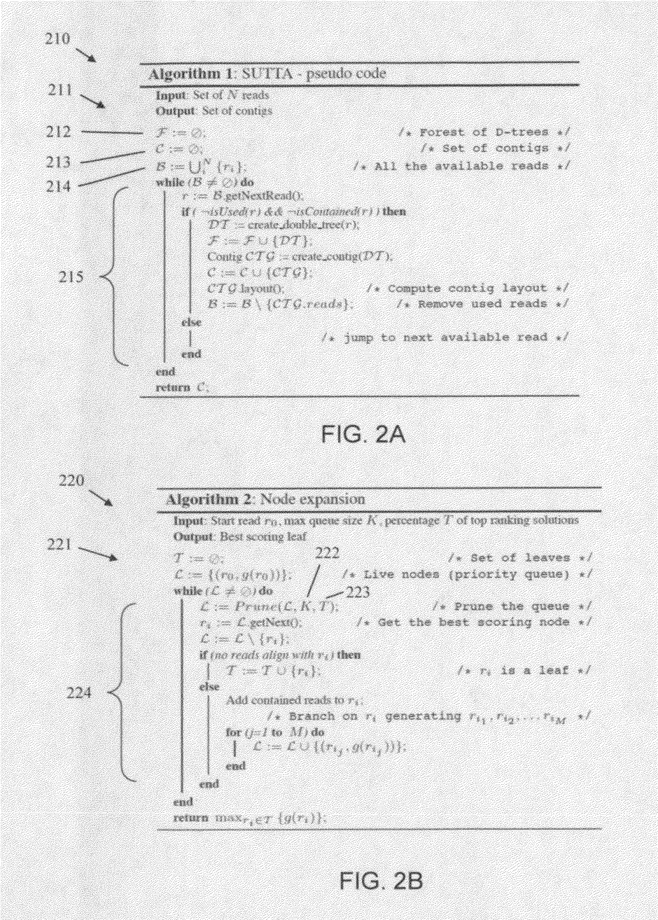

FIG. 3 shows an illustration of an exemplary procedure that can be involved in the construction of an exemplary contig. As shown, a double tree 310 can be created from a start node 311, with each tree 312 and 313 having nodes 314 based on reads 315, as can be shown in reads layout 330. The potentially exponential size of each tree 312 and 313 can be controlled by using certain exemplary structures of an assembly problem that can permit a quick pruning of many redundant branches of a tree. For example, according to certain exemplary embodiments of the present disclosure, substantial pruning can be done using only local structures of the overlap relations 316 among the reads 315, for example. It may not be prudent to spend time on expanding nodes that can create a suffix-path of a previously created path, as no information can be lost by delaying the expansion of the last node/read involved in such an exemplary “transitivity” relation, which can happen, for example, whenever there can be a transitivity edge between three or more consecutive reads.

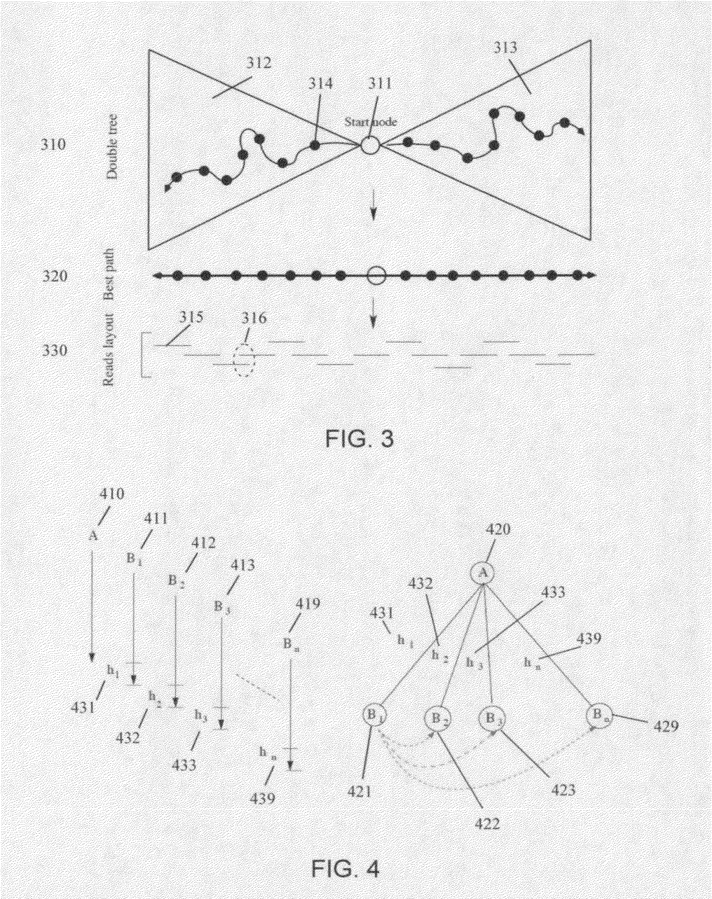

FIG. 4 illustrates exemplary transitivity pruning procedure in accordance with certain exemplary embodiments of the present disclosure. In this example, reads A 410, B₁ 411, B₂ 412, B₃ 413 . . . , Bₙ 419 can be n+1 reads with the exemplary layout shown in FIG. 4. The local structure of the resulting exemplary tree can have node A 410 with n children nodes B₁ 421, B₂ 422, B₃ 423 . . . , Bₙ 429. Since, as shown in this example, read B₁ 411 can overlap reads B₂ 412, B₃ 413 . . . , Bₙ 419, these nodes can appear as children of node B₁ 421 at the next level in the tree. Therefore, the expansion of nodes B₂ 422, B₃ 423, . . . , Bₙ 429 can be delayed because of the overlap of their corresponding reads, while read A 410 can depend on read B₁ 411. The expansion can be similar for nodes B₂ 422, B₃ 423 . . . , Bₙ 429. It can be possible for this exemplary pruning procedure to reduce a full tree structure into a linear chain of nodes. Additional optimization can be performed, for example, by evaluating the children in an increasing order of hangs (e.g., h1 431≦h2 432≦h3 433≦ . . . ≦hn 439, where hi can be the size of the hang for read Bi, the hang being the read portion that may not be involved in an overlap. This exemplary ordering can give a higher priority to, for example, reads with a higher overlap score.

According to exemplary shotgun sequencing projects, the sizes of the fragments generated can be carefully controlled, thus providing statistical information (e.g., mean and standard deviation) about the distance between the two reads sequenced from the ends of the same fragment, which can be called, for example, “paired-ends” or “mate-pairs”. According to certain exemplary embodiments of the present disclosure, within the exemplary assembly, mate-pair reads can be placed at a distance consistent with the size of the library from which they originated, and can be oriented towards each other. Reads that do not satisfy these constraints may not have their corresponding nodes expanded so that the sub-trees that could have otherwise been generated by these nodes/reads can be pruned.

The score function, or components of it, in a relatively simple possible setting can be based on the short-range information. For example, along a path, consecutives short-reads can overlap, but they can also satisfy other “derived” relationships. For example, provided that the genomic coverage can be higher than 3 (e.g., 3× coverage or higher), it could be expected that if sequence-reads A and B overlap, and B and C overlap, then there can be a relatively high probability that A and C also overlap. Thus, certain exemplary embodiments of the present disclosure can start with a very simple score function. An exemplary score function can use a “weighted transitivity” score. For example, along a path, if read A overlaps read B, and read B overlaps read C, it can score those overlaps strongly if in addition A and C also overlap.

An exemplary score function can be expressed, for example, as follows:

If (Overlap(A,B) && Overlap(B,C)) {

Score(A, B, C) =
[Score(A,B) + Score(B,C)]+ [Overlap(A,C) ? Score(A,C) : 0]
}

A simple generalization for higher coverage can be apparent to one having ordinary skill in the art in view of the teachings of the present disclosure. For example, scores may not resolve repeats or haplotypic variations. Thus, for this information to be properly accounted for, an exemplary score can be augmented with components based on long-range information (e.g., spanning a region of 150 Kb or greater, or 100 Kb or greater), for example.

Certain exemplary penalty functions can be used in the score to prune out (e.g., identify and reject) anomalous paths in an exemplary tree organizing the arrangements of sequence reads. For example, a path can be considered as an unlikely assembly solution if it overlays sequence reads in such a way that at certain locations, the local coverage far exceeds the global average coverage, and violates what can be expected in terms of the Poisson, or over-dispersed Poisson, Binomial, etc., distribution of the coverages. In another example, a path can be anomalous and thus, penalized if in the multiple sequence alignment induced by the overlays of the sequence-reads along this path, there can exist regions with distributions of misaligned bases and gaps that can be statistically significantly inconsistent with what could be expected by the distributions of single nucleotide polymorphisms and/or indelpolymorphisms, etc. There can be other local score functions, and penalty functions, that can be similar to the ones described herein above, as can be obvious to a one having ordinary skill in the art in view of the present disclosure.

In certain exemplary embodiments of the present disclosure, while the local components of the score, the transitivity and mate-pair pruning, and the penalty functions may not be sufficiently strong to validate a sequence assembly or disambiguate the haplotypic variations, they can provide for the elimination of an obviously and/or clearly bad and/or inaccurate assembly, very early on in the procedure with significantly simple efficient computation. In addition, it has been demonstrated that they can often be sufficiently powerful to create reasonably large-sized contigs, and/or even full sequences for small bacteria-sized genomes, thus making the relatively more computationally intensive steps being executed far more rarely than they can be otherwise executed.

According to further exemplary embodiments of the present disclosure, long-range information, for example, what information can be obtained from optical map alignment, reference sequence, base distribution frequency, and/or mated-pair distances, can be used to derive additional exemplary reward/penalty Bayesian terms in the over-all score function. These exemplary terms can ensure or substantially ensure that, for example, a reasonably long contig that can be suggested by a subpath of a path in the tree be consistent with the corresponding long-range information.

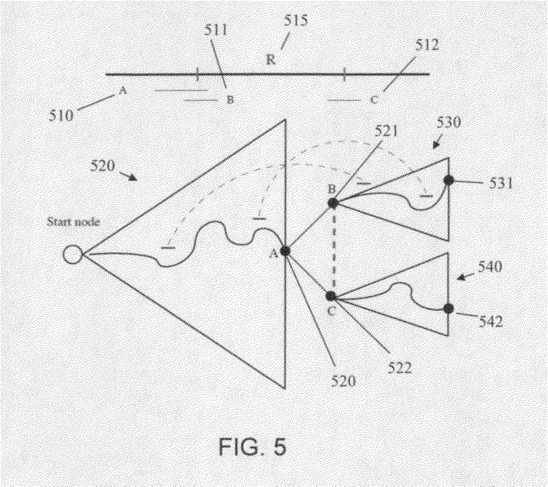

For example, FIG. 5 shows a diagram of an exemplary lookahead procedure in accordance with an exemplary embodiment of the present disclosure. For example, mate-pair data can be used to disambiguate repeat regions of the layout as it can be assembled. A potential repeat boundary location R 515 between reads A 510, B 511 and C 512 can be generated. For example, if read A 510 overlaps both reads B 511 and C 512, but read B 511 and read C 512 do not overlap each other, the missing overlap between reads B 511 and C 512 can be a possible repeat-boundary location R 515, making certain pruning decisions difficult. However, according to certain exemplary embodiments of the present disclosure, it can be possible to resolve this scenario by looking ahead into possible layouts generated by the reads B 511 and C 512, and keeping the node (e.g., node 531 or node 542) that generates a layout with the least number of unsatisfied constraints (e.g., consistent with mate-pair distances or restriction fragment lengths from optical maps). For example, as shown in FIG. 5, two subtrees 530 and 540 can be generated, one for node B 531 and the other for node C 542. The size of each subtree can be controlled by, for example, a parameter W, which can be the maximum height allowed for each node in the tree. For genomes with short repeats, a small value for W can be sufficient to resolve most repeat boundaries, and can be estimated, for example, from a k-mer analysis of the reads. With genomes of high complexity (e.g., one with a complex family of LINEs, SINEs and segmental duplications with varying homologies), relatively higher values of W can be used and be estimated adaptively. Once the two or more subtrees can be constructed for each node in the path, its pairing mate, if any, can be searched to collect only those mate-pairs crossing a connection point between the subtree(s). The best path can then be selected based on the overlap score. The quality of each path can be evaluated by, for example, a reward/penalty function corresponding to mate-pair constraints.

As another example, a subpath in a path of the tree of sequence-read-arrangements and the in silico ordered restriction maps that could be suggested by this subpath can be considered. Such in silico maps can be determined or computed, for example, only approximately by noting the occurrences of the restriction patterns among the sequence reads along the subpath, and inferring the base-pair distances among the consecutive detected sites. Certain errors can occur in such in-silico maps because of the homopolymeric compressions, such as, for example, incorrect or low-quality base-calls, loss of synchronizations in reaction steps, etc. Accordingly, the statistical properties of such computationally induced errors can be identified and incorporated into the score function, using, for example, a Bayesian algorithm/procedure in a manner that can be known to a person having ordinary skill in the art in view of the teaching provided in the present disclosure. Thus, for explanatory purposes, the following description of an exemplary embodiment according to the present disclosure assumes an error-free case.

According to such exemplary embodiments of the present disclosure, it can thus be assumed that a Bayesian prior starts with a subpath that can lead to an error-free valid in-silico ordered restriction map, and that the corresponding long-range information can be presented by an optical map of a single-molecule genomic DNA. This can be consistent with a hypothesized in-silico map upon various misalignments being explained in terms of error processes governing, for example, partial digestion, false optical cuts, chimerisms, sizing errors, etc. The better or best alignments, and the corresponding score values, can be computed using, for example, dynamic programming. If several single-molecule optical maps align well with many subpaths along a path in a tree organizing the sequence reads, then certain pairs of optical maps can overlap and have alignments in those overlapping regions. These global multiple alignments among the optical maps can be evaluated, for example, for their consistencies, and can be included in the over-all score function.

For example, the event of a cut missing in the optical map can be modeled as a Bernoulli process, yielding a parameter called partial digestion rate p_{c}<1. The corresponding term in the score function could be ln 1/(1−p_{c}). Similarly, assuming false-cuts to be distributed in terms of a Poisson process, with parameter p_{f}, the corresponding term in the score function could be ln 1/p_{f}. The sizing error can be modeled in terms of a Gaussian distribution with a mean a and standard deviation s. If the measured length can be 1, then the corresponding score could be given by a weighted sum-of-square function, where the corresponding term could be (1−a)²/s². Details of the overall score function, and how to efficiently compute such using a dynamic programming approach, can be understood to a person having ordinary skill in the art in view of the teachings of the present disclosure.

Long-range information, such as, for example, single-molecule-based optical ordered restriction maps, and sequence-reads, can be represented approximately by various geometric hashing schemes and stored in an easy-to-search hash table. According to certain exemplary embodiments of the present disclosure, the overall organization of the data structures, the software, and the implementation involving cycles of search-alignment-score-prune-and-unfold, can follow standard software engineering practice.

Similar procedures such as, for example, replacing or augmenting optical maps with mated pairs, ordered probe maps, sequencing-by-hybridization spectra, reference maps, population-wide polymorphism data, targeted maps of genomic regions, maps of base-pair composition distributions along a genomic region, maps of distributions of various physical or chemical properties (e.g., purine-pyrimidines, codons, affinities to other molecules, Gibbs free-energy, stacking energy, etc.) along a genomic region, can also be implemented in accordance with certain exemplary embodiments of the present disclosure.

The description of certain exemplary embodiments of the present disclosure provided herein can include an example of implementations of the procedural models using a relatively simple score function based on a local overlap between the reads, mate-pairs long range data to resolve repeat boundary regions (e.g. through look-ahead), its relative performance and accuracy with respect to other shotgun assembly procedures, and certain test examples with the genomes of Brucellasuis Wolbachia, and Staphylococcus Epidermidis as can be used in the exemplary embodiments shown in FIGS. 3-11, for example.

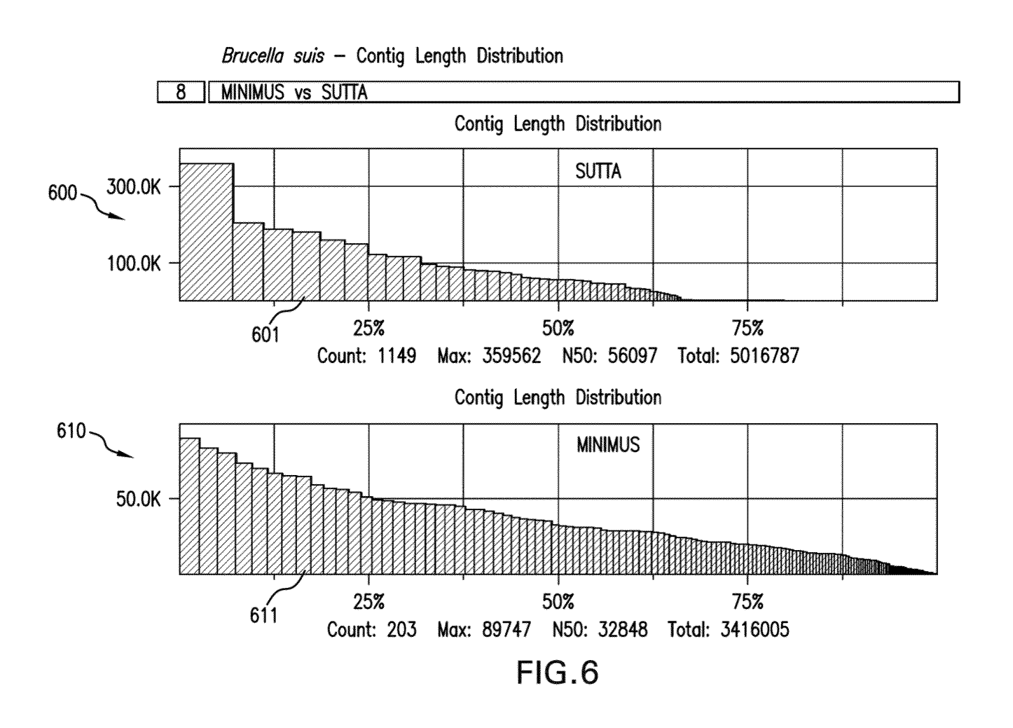

For example, FIG. 6 illustrates a graph of an example of Brucella suis contig length distributions. An exemplary contig length distribution 611 in accordance with certain exemplary embodiments of the present disclosure (“SUTTA”), shown in the top panel 610, can be compared with an example contig length distribution 621 according to another procedure (“MINIMUS”), shown in the bottom panel 620. As can be seen, the exemplary contig length distribution 611 in accordance with certain exemplary embodiments of the present disclosure, can provide more efficient results than the exemplary contig length distribution 621 according to an example of a MINIMUS procedure.

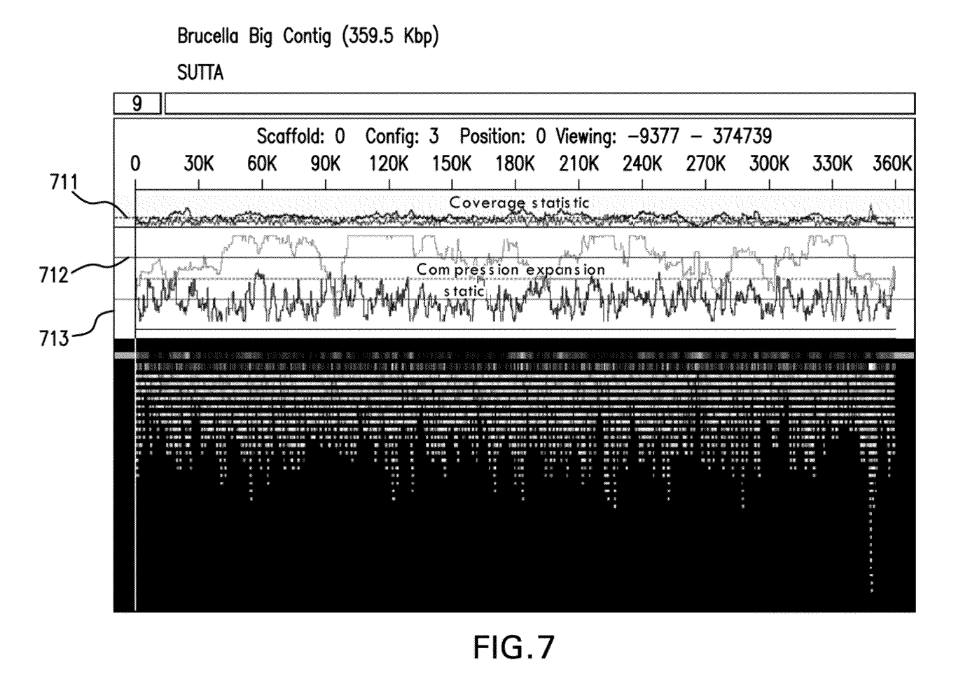

FIG. 7 illustrates an example of a Brucella suis big contig (e.g. 359.5 Kbp) in accordance with certain exemplary embodiments of the present disclosure. Exemplary coverage statistics 711 can be shown near the top of the figure. Exemplary compression expansion 712 can be shown directly below the exemplary coverage statistics 711, and exemplary static 713 can be shown directly below the exemplary compression expansion 712.

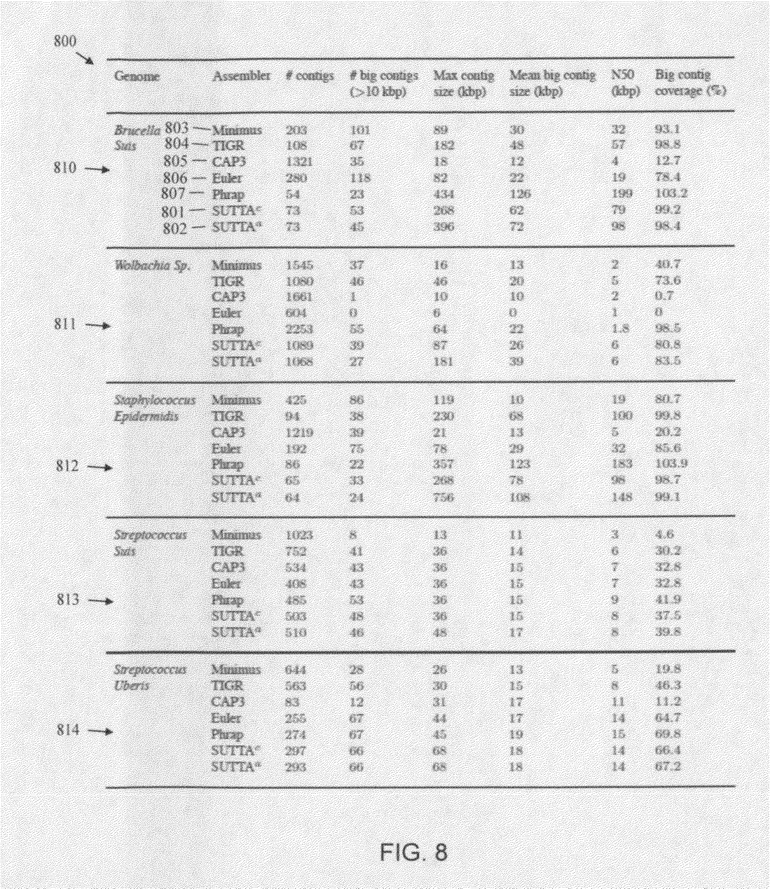

FIG. 8 illustrates an example of a table 800 providing comparison of exemplary embodiments according to the present disclosure, and examples of five other sequence assemblers (e.g. Minimus 803, TIGR 804, CAP3 805, Euler 806, Phrap 807). Two versions, according to certain exemplary embodiments of the present disclosure, can be shown in this exemplary comparison. SUTTA^{c} 801 can use a conservative approach, where an ambiguity encountered at a repeat boundary can be resolved by pruning the reads extending the current layout except the one with the highest overlap score. SUTTA^{a} 802 instead can use an aggressive strategy, where, for example, all extending reads at a repeat boundary can be expanded. As shown in table 800, there can be exemplary comparisons for BrucellaSuis 810, WalbachiaSp. 811, Staphylococcus Epidermidis 812, StreptocbccusSuis 813 and StreptococcusUberis 814.

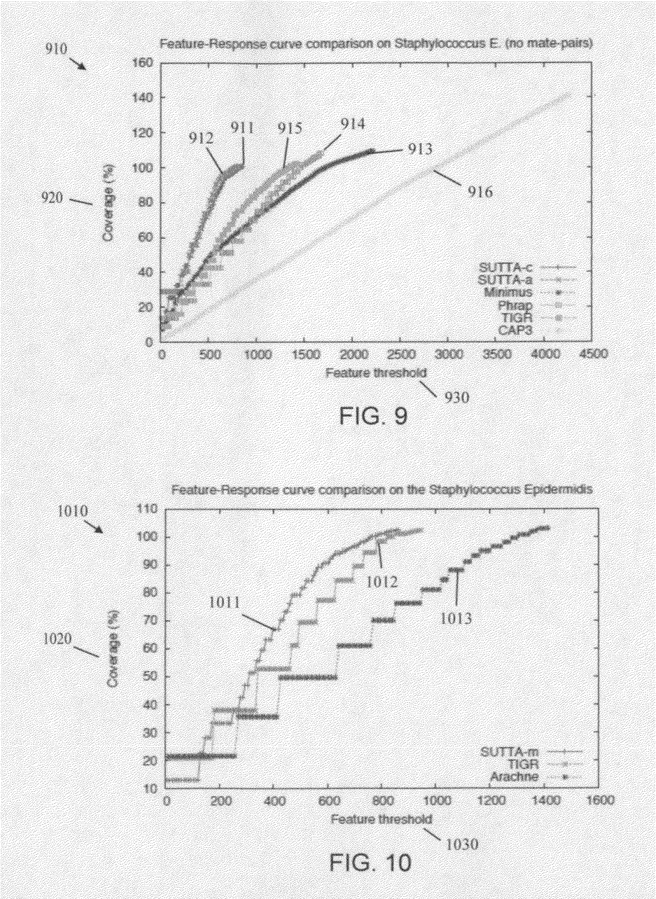

FIG. 9 shows an exemplary graph of “Feature-Response curve” for the Staphylococcus genome when no mate-pairs can be used in the assembly in accordance with an exemplary embodiment of the present disclosure. As shown, the exemplary Feature-Response curve 910 can illustrate a comparison of results from examples of sequence assemblers SUTTA^{c} 911, SUTTA^{a} 912, Minimus 913, Phrap 914, TIGR 915 and CAP3 916, the comparison being based on a genome coverage 920 and a feature threshold 930.

Exemplary Feature-Response curves according to the present disclosure can be provided as a new and more reliable metric than a contig size analysis, since a contig size analysis, as illustrated in FIG. 8, for example, can provide an incomplete and often misleading view of the real performance of different assemblers. Exemplary embodiments of a Feature-Response curve can characterize the sensitivity (e.g., coverage) of a sequence assembler as a function of its discrimination threshold (e.g., number of features). An A Modular Open Source whole-genome assembly (“AMOS”) package can be used, for example, to provide an automated assembly validation pipeline called “amosvalidate” that can analyze the output of an assembler using a variety of assembly quality metrics or features. Examples of features can include, for example, (M) mate-pair orientations and separations, (K) repeat content by k-mer analysis, (C) depth-of-coverage, (P) correlated polymorphism in the read alignments, and (B) read alignment breakpoints to identify structurally suspicious regions of the assembly.

According to certain exemplary embodiments of the present disclosure, after executing an exemplary amosvalidate procedure on an output of an assembler, each contig can be assigned a number of features that can correspond to doubtful regions of an example sequence. For example, in the case of mate-pairs checking (M), the tool can flag regions where multiple mate pairs can be mis-oriented or the insert coverage can be low. Given an example set of features, a response (e.g. quality) of the assembler output can then be analyzed as a function of the maximum number of possible errors (e.g. features) allowed in the contigs. For example, for a fixed feature threshold φ, the contigs can be sorted by size and, starting from the longest, tallied only if their sum of features can be ≦φ. For the example set of contigs shown in FIG. 9, the corresponding genome coverage 920 can be computed, leading to a single point of the Feature-Response curve.

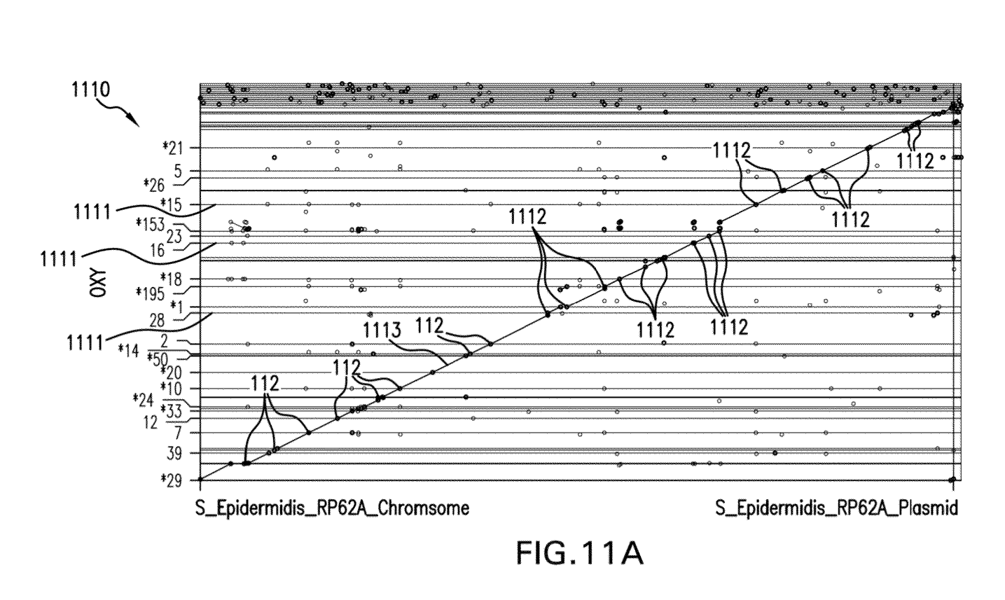

FIG. 10 shows an exemplary graph of an exemplary Feature-Response curve for the Staphylococcus genome comparing example results from different assemblers when mate-pairs can be used in an example assembly.

As shown in FIG. 10, the exemplary Feature-Response curve 1010 can provide a comparison of results from examples of sequence assemblers SUTTA-m 1011 according to an exemplary embodiment of the present disclosure, TIGR 1012 and Arachne 1013, the comparison being based on a genome coverage 1020 and a feature threshold 1030. Similarly to the example illustrated in FIG. 9, and in the example illustrated in FIG. 10, an exemplary embodiment of the present disclosure can outperform the assemblies from both TIGR and Arachne in terms of, for example, assembly quality.

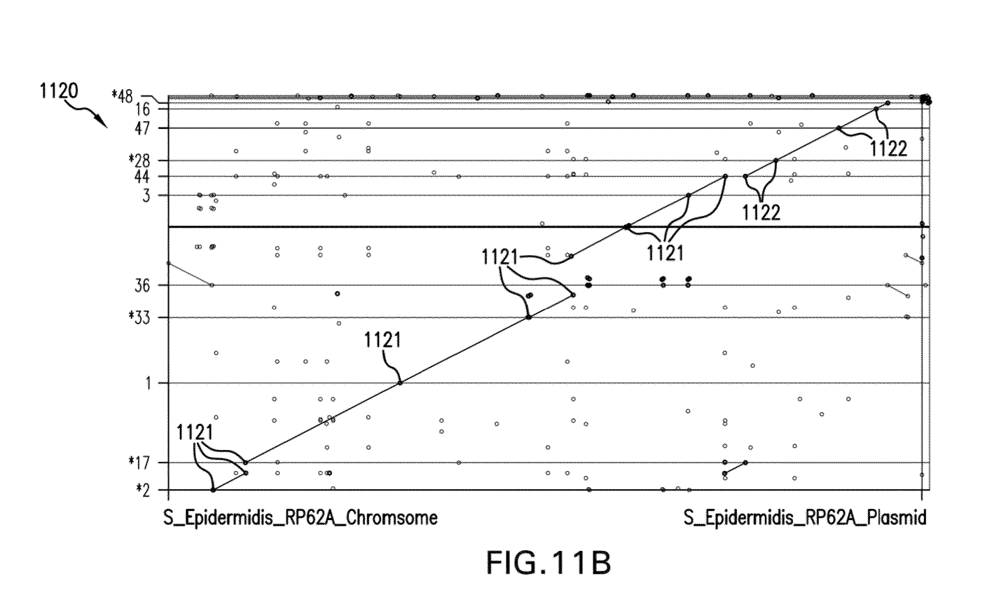

FIG. 11A illustrates an example of a dot plot alignment 1110 of the Staphylococcus genome assembled in accordance with an exemplary embodiment of the present disclosure. FIG. 11B illustrates an example of a dot plot alignment 1120 of the Staphylococcus genome assembled by TIGR. The horizontal lines 1111 can indicate the boundary between assembled contigs. A comparison of FIGS. 11A and 11B illustrates that the dot plot alignment of FIG. 11A SUTTA outperformed the previously known methods.

A comparison of illustration of FIGS. 11A and 11B provides that the example SUTTA assembly in accordance with exemplary embodiments of the present disclosure shown of FIG. 11A can match well with the reference sequence, having a near perfect alignment, as provided by the number of matches 1112 lying along the main diagonal 1113. In contrast, for example, TIGR shows many large assembly errors based on plots 1122, for example, many of them being due to chimeric joining of segments from two distinct non-adjacent regions of the genome. Additional examples of dot plots including, for example, those for the other genomes and associated Feature-Response curves illustrated in FIGS. 9, 10 and discussed herein-above also show the example SUTTA's outperformance.

Following are certain examples of exemplary statistics determined by tests conducted in connection with an implementation according to various exemplary embodiments of the present disclosure. For example, the computational time using a typical personal computer with a 1.8 GHz to 2.4 GHz processor, can be 20 minutes for Brucella suis, and can increase up to 1 hour for Wolbachia sp. The computational time and accuracy can be found to be significantly dependent upon the underlying queue size, for example. Because relatively higher values of a queue size can increase the computational time (e.g., because of the 0-1 law phenomena described above), optimal values for a queue size can be selected to reduce complexity, while maintaining the quality of the results. In addition, strong bounds on the score function can facilitate a drastic reduction of the search space, and the computational time, with a minimum loss in quality.

Exemplary embodiments of the present disclosure can be implemented using an AMOS infrastructure, for example. AMOS can be used primarily for, for example, various bookkeeping facilities, software engineering features and visualization. For example, exemplary embodiments of the present disclosure can use an AMOS bank as a central data-structure consisting of a collection of indexed files comprising assembly related objects (e.g., reads, inserts, overlaps, contigs, scaffolds, etc.) to keep track of various genomic objects. Subroutines in the assembly pipeline can communicate with each other using the bank as an intermediate storage space. A relatively simple overlapper routine based on “minimizers” technique can be used to, for example, reduce by an order of magnitude, the number of k-mers considered in the initial phase of overlapping. Certain exemplary embodiments according to the present disclosure can use a Churchill-Waterman procedure for, for example, computing the consensus bases using subroutines in AMOS's consensus computation package, as it can provide a parametric implementation in the form of columns in a multiple alignment of reads. The AMOS's Hawkeye visualizer can be used, for example, to facilitate inspection of large-scale assembly data, which can help to substantially minimize the time used to detect mis-assemblies, and make accurate judgments of assembly quality. The exemplary dot-plot can be generated using the MUMmer alignment tool, for example.

### Exemplary Embodiments for Scaling and Parallelizing Sequence Assembly

Unlike the traditional heuristics-based approaches, the exemplary assembly procedure, SUTTA, according to an exemplary embodiment of the present disclosure can assemble each contig independently and dynamically, one after another, using a B&B strategy. While SUTTA can proceed with the exemplary idea of searching the complete space of assembly solutions, SUTTA can avoid that an explicit enumeration can be very difficult and likely practically impossible (e.g., due to exponential time and space complexity), by using B&B to limit the search to a smaller subspace that can contain the optimum. At a high level, SUTTA's exemplary framework can rely on a rather simple and easily verifiable definition of feasible solutions, for example, as “consistent layouts.” This exemplary procedure can generate potentially most, or all, possible consistent layouts in a genome, for example, organizing them as paths in an exemplary “double tree” structure rooted at a randomly selected “seed” read. An exemplary path can be progressively evaluated in terms of an optimality criterion, for example, encoded by a set of score functions based on the set of overlaps along the layout.

This exemplary strategy can facilitate the exemplary procedure to concurrently assemble, and determine the validity of the layouts (e.g., with respect to various long-range information, such as optical mapping) through well-chosen constraint-related penalty functions. Complexity and scalability problems can be addressed by pruning most of the implausible layouts via a B&B scheme. Ambiguities, for example, resulting from repeats or haplotypic dissimilarities, can occasionally delay immediate pruning, and can require the procedure to perform look-ahead, but in practice, the exemplary computational cost of these events can be low. Because of the generality and flexibility of the exemplary procedure (e.g., depending only on the underlying technologies through the choice of score and penalty functions), the exemplary SUTTA procedure can be extensible to deal with possible future (e.g., unknown) technologies. It can also facilitate concurrent assembly and validation of multiple layouts, thus providing a flexible framework that can combine short- and long-range information from different technologies (e.g., optical or dilution mapping). Exemplary embodiments of SUTTA can also utilize supervised learning to cull some of the important and/or the most informative metrics, for example, out of those currently under examination (e.g., N50 or overlap structures, or standard Amosvalidate features) to optimize a score that can ensure that only the most “reasonable” layout can be generated and used.

According to another exemplary embodiment of the present disclosure, it can be possible to scale the exemplary SUTTA procedure to handle larger genomes, for example, at the macro level, primarily by devising substantial speed improvements, which can be achieved in at least the following two ways: (a) improving the single-thread execution time, and (b) parallelizing the basic exemplary SUTTA procedure. One of the more expensive tasks that the exemplary modified exemplary SUTTA procedure can perform may involve the Overlapper, which can be scaled using a divide-and-conquer approach, in which the entire data set of reads can be divided into multiple “prefix trees” that can be accessed independently and in parallel. The exemplary approach can, for example, first divide a large number of sets of reads, and can organize them in several independent data structures, for example, in such a manner that each data structure can be searched to find all the reads that exactly or inexactly overlap with a particular read.

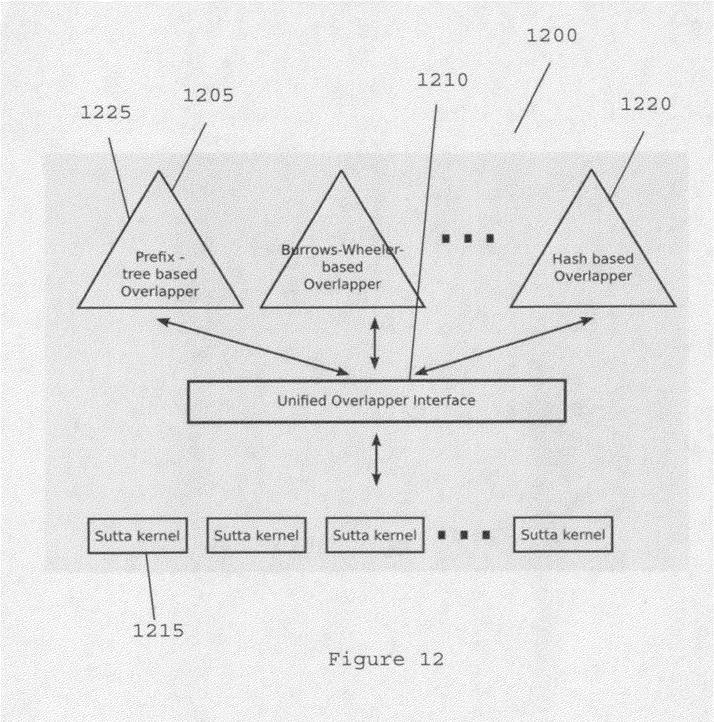

FIG. 12 illustrates an exemplary chart of an exemplary overlapper infrastructure 1200. The task of an exemplary overlapper 1205 can involve providing all of the overlappers 1205 with a given read (e.g., read from a SUTTA kernel 1215), and returning all the reads in the dataset that overlap with the given read. A set of allowed start positions within the given read can be specified, in addition, in order to restrict the set of returned reads. Different exemplary overlappers 1205 can utilize different data structures optimized for specific types of data and for different error rates in the genome sequencing. If the error rate of the genome sequencer can be low (e.g., 1 in 1 million) a sorting overlapper can be used. If the error rate can be at or near 0, a Burrows-Wheeler based Overlapper 1230 can be used. If the error rate can be high (e.g., 1 in 100), various overlappers can be used depending on the size of the reads in base pairs. For example, short reads (e.g., less than 100 bp) can be stored in an overlapper based on hashing 1220 of the data, and long reads (e.g., greater than 200 bp) can be stored in an overlapper based on a prefix tree 1225. The data can be distributed across multiple overlappers, which can be queried in parallel. For example, each SUTTA kernel can query all of the Overlappers 1215 using a Unified Overlapper Interface 1210, which can be separate from, or part of, the SUTTA kernel 1215. The Unified Overlapper Interface 1210 can be used to transparently query this hybrid and distributed overlapper infrastructure 1200, facilitating multiple SUTTA kernels 1215 to concurrently access the overlappers 1205 without having to know exactly what types of, and how many, overlapper instances are used. Each SUTTA kernel can use its own processor, which can facilitate a substantial speed improvement in generating an entire sequence.

When each SUTTA kernel 1215 queries all of the overlappers, and an overlapping sequence can be found, the SUTTA kernel can be modified (e.g., built-upon or grown) to include the original base pairs and the base pairs of the overlapping sequencing. The SUTTA kernel 1215 can iteratively query all of the Overlappers 1215 until the entire sequence can be generated. During the iterative query, various SUTTA kernels 1215 can be grown to create larger SUTTA kernels, which can eventually be merged with one another until the entire sequence can be generated. Such a parallel approach will be described in more detail below.

Each SUTTA kernel 1215 can be composed of a forward branch and a backward branch (e.g., overlapping sequences overlapping either the beginning or the end of the sequence). Such overlapping branches (e.g., D-trees can also be created in parallel). Additionally, if multiple overlapping sequences are found by the Overlappers 1205, branches (e.g., in the forward direction and/or in the backward direction) can be generated. These branches can be optimized to collapse multiple branches into a single branch, as will be discussed below.

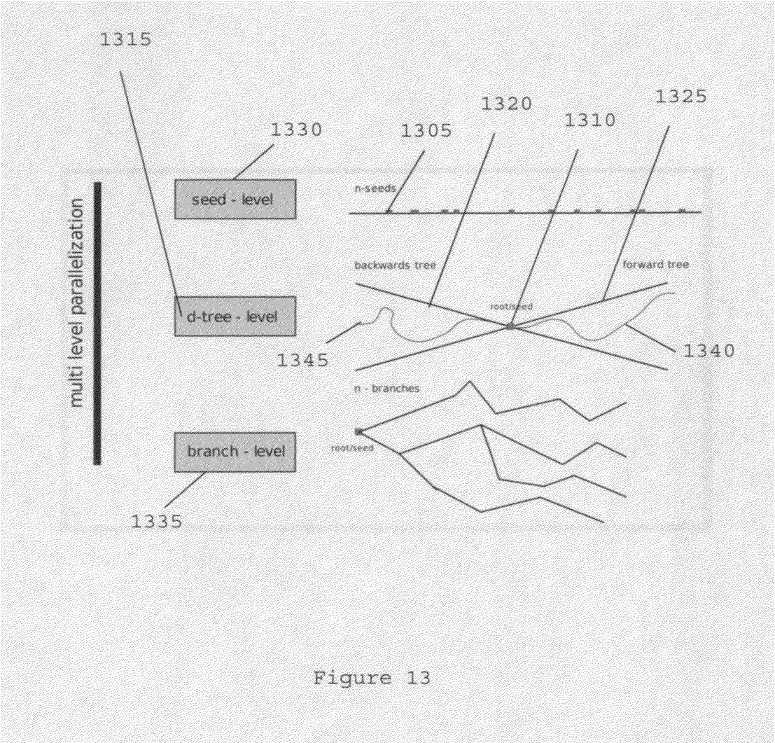

FIG. 13 shows an exemplary diagram illustrating a multi-level parallelization procedure according to an exemplary embodiment of the present disclosure. The exemplary SUTTA procedure can be provided to be multi-level parallel, facilitating every level of the exemplary execution pipeline to be parallelized (e.g., seed level/root level 1330, D-tree level 1315 and/or branch level 1335).

For example, seeds 1305 can serve as the root 1310 of the double tree 1315 (See e.g., FIG. 1). For the parallelization of SUTTA, multiple seeds 1305 can be generated (e.g., each using its own processor) according to a particular desired seeding strategy (described in detail below) and then extended in parallel (e.g., multiple seeds can be used for multiple SUTTA kernels 1215 as described above, and grown as described above). Any number of seeds 1305 can be picked, which can result in one contig per seed 1305. In order to obtain a single contig, SUTTA can be run recursively (e.g., the generated contigs resulting from a vast number of seeds 1305 can serve as reads and potential seeds/roots 1310 for the next iteration).

Since each seed 1305 can represent the root 1310 of a D-tree 1315, both sides/directions of the root of D-tree 1315 (e.g., the backwards tree 1320 and the forward tree 1325) can be generated in parallel as well (e.g., each side/direction can be generated using a different processor), which can form the final contig. During the exploration of the D-tree 1315 (e.g., the backwards tree 1320 and the forward tree 1325), multiple paths 1340 and 1345 can be generated and evaluated in parallel (e.g., multiple branches for each side/direction can also be generated using a different processor). Combining the exemplary multi-level parallelization procedure of the exemplary SUTTA kernels, and the distributed Overlapper, can facilitate the exemplary SUTTA to utilize parallel and massively parallel systems (e.g., a separate processor for each seed, a separate processor for each direction away from each seed, and a separate processor for each branch of each direction away from each seed).

The exemplary parallelization procedure at the seed level 1330 can be facilitated by, for example, running multiple SUTTA cores in parallel, each one with their own distinctive root node 1320. Most or all cores can operate completely independently from one another, but can also communicate by passing information through asynchronous message queues. This exemplary information can contain information such as estimated global position of the contig (e.g. derived according to optical maps), relative position information (e.g. mate pair information) and read information (e.g. which read has been used, how often, etc.). The different SUTTA cores can run as one process each, which can facilitate them to be distributed across multiple virtual or physical machines.

The exemplary parallelization procedure on the D-tree level 1315 can be facilitated by building both the forward 1325 and the backward 1320 tree in parallel. Similar to the parallelization of the seed level 1330, both forward tree 1325 and backward tree 1320 can be built independently, and they can share information without the need for message queues, since they both can have access to the same memory, and can therefore directly share information. This exemplary procedure can be implemented through multi-threaded application design, which can utilize the fact that all threads can run on the same physical or virtual machine.

The exemplary parallelization procedure at the branch level 1335 can be facilitated by a process of expanding the search space in parallel within either of the trees (e.g., the forward 1325 or the backward tree 1320). This exemplary strategy can utilize multiple expansion windows (e.g., one for each branch) that can be processed in parallel; relevant information between the threads can be exchanged, as needed.

Further, the multiple seeds 1305 can be generated, according to any desired seeding strategy and then extended in parallel. Seeding strategies can determine the process of finding a suitable root node 1310 for SUTTA. Various different exemplary seeding strategies can be used, and can include, for example:
(1) Selecting a random read from the set of all reads as a root. This approach can lead to preferring reads that originate from repeat regions as well as reads that originate from areas of the genome with high coverage.
(2) Selecting a random read from all distinct reads. This strategy can facilitate picking each seed 1305 with equal probability regardless of whether a specific read originates from an area of high coverage and/or repeat region.
(3) Selecting the seed 1305 according to global position information about a read (e.g., optical maps). Picking the seed 1305 according to global position information can facilitate picking the seed 1305 that can have a higher probability to originate from a specific location in the genome. This strategy is important for targeted sequencing/genome assembly as well as in ensuring spatial separation of the seed 1305s, when working with a large number of the seeds 1305.

As indicated herein, the exemplary multi-level parallelization approach can involve executing a group of procedure at different levels: namely, the seed-level 1330: each seed can be handled by a different processor; the D-tree-level 1315: each tree, and the resulting contig, can be assigned to a different processor; and/or the branch-level 1335: each branch (e.g., governed by its unitigs) can be processed by its own unique processor assigned to it.

In other exemplary embodiments of the present disclosure, to compute or determine exemplary overlaps, it can be possible to utilize hashing, randomized substring-search, finite-automata based methods, hidden-markov-model based approaches and/or dynamic programming. Another exemplary approach to the same or similar problem can combine each pool of reads with a single or a plurality of query-reads and sort them (e.g., using quick-sort) to recover all the pair-wise overlaps. Furthermore, the exemplary modified SUTTA's kernel, in at least one exemplary embodiment, can be redesigned and reengineered so that it can take advantage of modern multi-core microprocessor (e.g., with 16 to 32 core) architectures. According to such exemplary embodiments, it can be possible to include an optimization of the code used in the D-tree generation, which can be complicated by the fact that it can benefit from efficiently performing transitivity collapse (e.g., to keep the search tree skinny) and looking-ahead (e.g., to disambiguate repeat boundaries and haplotypic differences).

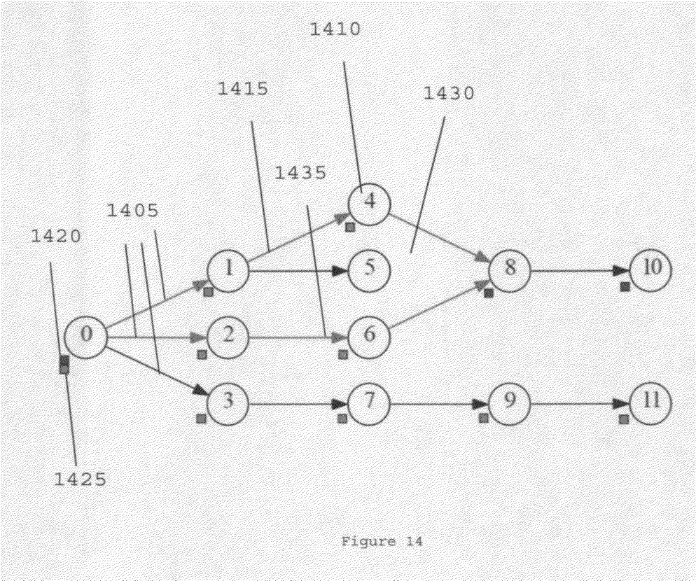

FIG. 14 illustrates an exemplary graph of an exemplary optimization procedure. Starting from a given read (e.g., Node 0), the procedure can build up the complete overlap graph within a given “expansion window,” for example, up to a given distance from the given read. An exemplary transitivity collapse can be performed as reads are inserted into the graph, by blocking the insertion of edges that can subsume a sequence of existing edges, and cutting existing edges, which can be subsumed by a sequence of newly inserted edges. This online transitivity collapse can assist to reduce peak memory consumption, catching most occurrences of transitive edges if reads can be added to the graph in increasing order of overlap start position. Remaining transitive edges can be removed in a post-processing procedure. The exemplary optimization procedure can include a flow-based detection of bubble 1430 (e.g., a closed loop path between 2 nodes, such as a bubble formed between nodes 0, 1, 4, 8, 6, 2, and 0) within expansion windows, as explained below, which can be caused by read errors, haplotypic differences, or repeat regions, and hypothesis branching, as well as parallel exploration of alternative hypotheses. FIG. 14 illustrates the use of the multiple flow directions 1405 to detect bubble 1430, and restrict branching only to the exploration of alternative assembly hypotheses. For example, instead of creating multiple branches (e.g., Branch 1 including Nodes 0, 1, 4, 8 and 10, and Branch 2 including Nodes 0, 2, 6, 8 and 10), a single branch of bubble 1430 can be selected (e.g., multiple branches can be collapsed into a single branch), along with a note that a bubble existed, or another branch existed, between two nodes (e.g., Nodes 0 and 8). Such exemplary collapsing can facilitate a decreased generation time, as the number of branches can be decreased.

Varying flows can be transmitted backwards from the nodes 1410 (e.g., Node 4) at the end of the current expansion window, having an intensity that can distribute over local branches (e.g., Node 8). Different flows can be assigned different colors, resulting in “colored flows”, and the flow values can be described in terms of what can be referred to as “intensity”. For example, a blue flow 1400 can distribute over several parallel paths, and can get lighter (e.g., at node 2) along each of these paths because there can be less of it.

The bubbles 1430, which can include alternate paths 1415 and 1435, can be detected and handled locally. If, for example, different colored flows jointly reach full intensity at a specified minimum distance from the end of the expansion window (e.g., the flows 1420 and 1425 joining at node 0), these paths can be considered to be distinct alternatives, and can be independently explored in parallel (e.g., path from 0 to 10 and path from 0 to 11); dead ends, which can be caused by read errors (e.g., at node 5), can be detected and pruned from the graph.

In exemplary mirroring, the computational complexity issues associated with the formulation of the sequence assembly problem, the correctness of the formulation can be problematic. For example, according to certain exemplary embodiments, the Shortest-Super-String Problem (“SSSP”) can be included and/or utilized which can encourage a repeat-induced compression, which may not be rectified by the De Bruijn graph or string-graph formulation, as these graphs with loops, or read-errors, can lead to non-unique ambiguous solutions. Thus, an exemplary modified formulation can be complex, although it can lead to a well-defined constrained global optimization problem (e.g., with constraints induced by coverage, statistics of the genome structures, long-range maps, etc.). Such exemplary formulation, and the rigorous mathematical solutions it can induce, can lead to a self-validated, haplotypic and efficient whole-genome assembly.

In another exemplary approach, it is possible to utilize an exemplary beam search procedure to produce more than one best-scoring solution. For example, an exemplary overlap graph can be fully expanded for a given fixed window, within which all possible paths can be examined and scored. In addition, potential alternative branches can be identified. The exemplary window can then be moved, and alternative branches can be pursued in parallel, for example, reflecting different potential solutions. These exemplary solutions can be compared against each other, or tested using long-range maps for hypothesis testing, validation, or statistical significance (e.g., p-value).

### Exemplary Assembled Genomes Validated by Low-Resolution Long-Range Maps

In another exemplary embodiment of the present disclosure, SUTTA's global optimizing procedure can create a highly validated assembly of a genome from short reads, or combined with long reads, as well as various kinds of long-range information (e.g., mate pairs, strobed sequences, optical maps, dilution maps, etc.). The exemplary SUTTA procedure can dovetail between sequence-assembly and validation, or physical map assembly in parallel, and can proceed with a performance superior to exemplary greedy assembly procedures, for example, because of its ability to detect failure in overlap consistency or transitivity collapse. Because of sequencing errors (e.g., dead ends, and p-bubble), repeat boundary or haplotypic ambiguity, it can perform a look-ahead. When the exemplary look-ahead sub-procedure can be quickly and correctly handled, exemplary embodiments of the exemplary SUTTA procedure can provide the desired efficiency and/or accuracy. The fast and correct resolution can be obtained by scoring the look-ahead paths using their consistency with mate pairs and/or optical maps and/or dilution maps.

### Exemplary Assembled Genomes Validated by Lay-Out Features

Complex genomic structures, intricate error profiles and error-prone long-range information can conspire in convoluted ways to make de novo sequencing tasks challenging, and can be handled by different sequence assemblers in idiosyncratic manners. This can be further complicated when no accurate reference genome can be available to assess the correctness of the assembled contigs. Furthermore, widely used metrics (e.g., N50 contig size), for this exemplary purpose, can be highly misleading, since they only may emphasize size, poorly capturing the contig quality. The exemplary approach of an exemplary embodiment of the present disclosure can rely on producing multiple solutions that can then be filtered by additional hypothesis-driven score functions (e.g., PCR, micro-array, dilution, optical maps, etc.).

FIG. 15 shows a block diagram of an exemplary embodiment of a system according to the present disclosure. For example, exemplary procedures in accordance with the present disclosure described herein can be performed by a processing arrangement and/or a computing arrangement 1502. Such processing/computing arrangement 1502 can be, e.g., entirely or a part of, or include, but not limited to, a computer/processor 1504 that can include, e.g., one or more microprocessors, and use instructions stored on a computer-accessible medium (e.g., RAM, ROM, hard drive, or other storage device).

As shown in FIG. 15, for example, a computer-accessible medium 1506 (e.g., as described herein above, a storage device such as a hard disk, floppy disk, memory stick, CD-ROM, RAM, ROM, etc., or a collection thereof) can be provided (e.g., in communication with the processing arrangement 1502). The computer-accessible medium 1506 can contain executable instructions 1508 thereon. In addition or alternatively, a storage arrangement 1510 can be provided separately from the computer-accessible medium 1506, which can provide the instructions to the processing arrangement 1502 so as to configure the processing arrangement to execute certain exemplary procedures, processes and methods, as described herein above, for example.

Further, the exemplary processing arrangement 1502 can be provided with or include an input/output arrangement 1514, which can include, for example, a wired network, a wireless network, the internet, an intranet, a data collection probe, a sensor, etc. As shown in FIG. 15, the exemplary processing arrangement 1502 can be in communication with an exemplary display arrangement 1512, which, according to certain exemplary embodiments of the present disclosure, can be a touch-screen configured for inputting information to the processing arrangement in addition to outputting information from the processing arrangement, for example. Further, the exemplary display 1512 and/or a storage arrangement 1510 can be used to display and/or store data in a user-accessible format and/or user-readable format.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, e.g., data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

### EXEMPLARY REFERENCES

The following references are hereby incorporated by reference in their entireties.
[1] T. S. Anantharaman, B. Mishra, and D. C. Schwartz. Genomics via optical mapping ii: Ordered restriction maps. Journal of Computational Biology, 4(2):91-118, 1997.
[2] T. S. Anantharaman, B. Mishra, and D. C. Schwartz. Genomics via optical mapping iii: Contiging genomic dna. In ISMB, pages 18-27, 1999.
[3] R. Bisiani. Encyclopedia of Artificial Intelligence, chapter Beam search, pages 56-58. Wiley & Sons, 1987.
[4] P. Ferragina and G. Manzini. Opportunistic data structures with applications. In FOCS, pages 390-398, 2000.
[5] A. Land and A. Doig. An automatic method of solving discrete programming problems. Econometrica, 28(3):497-520, 1960.
[6] F. Menges, G. Narzisi, and B. Mishra. Totalrecaller: Improved accuracy and performance via integrated alignment & base-calling. Bioinformatics, 5(7), 2011.
[7] B. Mishra. The genome question: Moore vs. Jevons. J. of Computing (of the Computer Society of India), 2012. To appear.
[8] G. Narzisi. Scoring-and-Unfolding Trimmed Tree Assembler: Algorithms for Assembling Genome Sequences Accurately and Efficiently. PhD thesis, Department of Computer Science, Courant Institute of Mathematical Sciences, New York University, 2011.
[9] G. Narzisi and B. Mishra. Comparing de novo genome assembly: The long and short of it. PLoS ONE, 6(4):e19175, 2011.
[10] A. Phillippy, M. Schatz, and M. Pop. Genome assembly forensics: Finding the elusive misassembly. Genome biology, 9:R55, 2008.
[11] F. Vezzi, G. Narzisi, and B. Mishra. Feature-by-feature—evaluating de novo sequence assembly. PLoS ONE, 7(2):e31002, 02 2012.
[12] Smith, L. M. et al. “Fluorescence Detection in Automated DNA Sequence Analysis,” Nature, 321(6071); 674-679, 1986.
[13] Nyren, P. et al., “Solid Phase DNA Minisequencing by an Enzymatic Luminometric Inorganic Pyrophosphate Detection Assay,” Annal Biochem 208(1): 171-175, 1993.
[14] Ronaghi, M. et al., “PCR-Introduced Loop Structure as Primer in DNA sequencing,” Biotechniques, 25(5): 876-884, 1998; Margulies, M. et al., “Genome Sequencing in Micro-fabricated High-Density Picoliter Reactors,” Nature, 437(7057): 376-380, 2005.
[15] Margulies, M. et al., “Genome Sequencing in Microfabricated High-Density Picolitre Reactors,” Nature, 437(7057): 376-380, 2005.
[16] Barany, F., “The Ligase Chain Reaction in a PCR World,” PCR Methods Appl., 1(1): 5-16, 1991.
[17] Nickerson, D. A., et al., “Automated DNA Diagnostics Using an ELISA-Based Oligonucleotide Ligation Assay,” PNAS, 87(22); 8923-8927, 1991.
[18] Drmanac, R., et al., “DNA Sequence Determination by Hybridization: A Strategy for Efficient Large-Scale Sequencing,” Science, 260(5114): 1649-1652, 1993
[19] Broude, N. E., et al., “Enhanced DNA Sequencing by Hybridization,” PNAS, 91(8):3072-3076, 1994.
[20] Levene, M. J., et al., “Zero-Mode Waveguides for Single-Molecule Analysis at High Concentrations,” Science, 299(5607): 682-686, 2003.
[21] Fologea, D. et al., “Detecting Single Stranded DNA with a Solid State Nanopore,” Nano Letter, 5(10):1905-1909, 2005.
[22] Meller, A., et al., “Rapid Nanopore Discrimination Between Single Polynucleotide Molecules, PNAS, 97(3): 1079-1084, 2000.
[23] Kim, S. et al., Genome Sequencing Technology and Algorithms, Artech House, London, 2008.
[24] X. Huang and A. Madan, “CAP3: A DNA Sequence Assembly Program,” Genome Research, 9(9): 868-877, 1999.
[25] X. Huang et al., “PCAP: A Whole Genome Assembly Program,” Genome Research, 13(9): 2164-2170, 2003.
[26] P. Green, http://www.phrap.org; G. Sutton et al., “TIGR Assembler: A New Tool for Assembling Large Shotgun Sequencing Projects,” Genome Science and Technology, 1(1): 9-19, 1995.
[27] J. D. Kececioglu, E. W. Myers, “Combinatorial Algorithms for DNA Sequence Assembly,” Algorithmica, 13(1-2): 7-51, 1995.
[28] E. W. Myers et al., “A Whole-Genome Assembly of Drosophila,” Science, 287(5461): 2196-2004, 2000.
[29] J. C. Venter et al., “The Sequence of the Human Genome,” Science, 291(5507): 1304-1351, 2001.
[30] S. Batzoglou et al., “Arachne: A Whole-Genome Shotgun Assembler,” Genome Research, 12(1): 177-189, 2002.
[31] P. A. Pevzner et al., “An Eulerian Path Approach to DNA Fragment Assembly,” PNAS, 98(17): 9748-9753, 2001.
[32] Z. Lai. et al., “A Shotgun Sequence-Ready Optical Map of the Whole Plasmodium falciparum Genome,” Nature Genetics, 23(3): 309-313, 1999.
[33]; A. Lim et al., “Shotgun optical maps of the whole Escherichia coli O157:H7 genome,” Genome Research, 11(9): 1584-93, September 2001.
[34] W. Casey, B. Mishra and M. Wigler, “Placing Probes along the Genome using Pair-wise Distance Data,” Algorithms in Bioinformatics, First International Workshop, WABI 2001 Proceedings, LNCS 2149:52-68, Springer-Verlag, 2001.
[35] B. Mishra, “Comparing Genomes,” Special issue on “Biocomputation:” Computing in Science and Engineering., pp. 42-49, January/February 2002.
[36] J. West, J. Healy, M. Wigler, W. Casey and B. Mishra, “Validation of S. pombe Sequence Assembly by Micro-array Hybridization,” Journal of Computational Biology, 13(1): 1-20, January 2006.
[37] C. Aston, B. Mishra and D. C. Schwartz, “Optical Mapping and Its Potential for Large-Scale Sequencing Projects,” Trends in Biotechnology, 17:297-302, 1999.
[38] J. Jing et al., “Automated High Resolution Optical Mapping Using Arrayed, Fluid Fixated, DNA Molecules,” Proc. Natl. Acad. Sci. USA, 95:8046-8051, 1998.
[39] J. Lin et al. “Whole-Genome Shotgun Optical Mapping of Deinococcus radiodurans,” Science, 285:1558-1562, September 1999.
[40] J. Jing et al., “Automated High Resolution Optical Mapping Using Arrayed, Fluid Fixated, DNA Molecules,” Proc. Natl. Acad. Sci. USA, 95:8046-8051, 1998.
[41] T. Anantharaman et al. “A Probabilistic Analysis of False Positives in Optical Map Alignment and Validation,” WABI 2001, August 2001.
[42] T. Anantharaman et al. “Genomics via Optical Mapping III: Contiging Genomic DNA and variations,” ISMB99, August 1999.
[43] T. Anantharaman et al. “Fast and Cheap Genome wide Haplotype Construction via Optical Mapping,” Proceedings of PSB, 2005.
[44] T. Anantharaman et al. “Genomics via Optical Mapping II: Ordered Restriction Maps,” Journal of Computational Biology, 4(2): 91-118, 1997.
[45] B. Mishra and L. Parida, “Partitioning Single-Molecule Maps into Multiple Populations: Algorithms And Probabilistic Analysis,” Discrete Applied Mathematics, 104(1-3): 203-227, August, 2000.
[46] T. Anantharaman et al. “A Probabilistic Analysis of False Positives in Optical Map Alignment and Validation,” WABI 2001, August 2001.
[47] T. Anantharaman et al. “A Probabilistic Analysis of False Positives in Optical Map Alignment and Validation,” WABI 2001, August 2001.
[48] The International HapMap Consortium, “The International HapMap Project,” Nature 426(18): 789-796, 2003.
[49] The International HapMap Consortium, “A Haplotype Map of the Human Genome,” Nature, 437(27):1299-1320, 2005.
[50] M. Stephens and P. Donelly, “A Comparison of Bayesian Methods for Haplotype Reconstruction from Population Genotype Data,” American Journal of Human Genetics, 73(5): 1162-1169, 2003.
[51] L. Feuk, A. R. Carson, and W. Scherer, “Structural Variation in the Human Genome,” Nature Review Genetics, 7(2): 85-97, 2006.
[52] J. Sebat et al., “Large-Scale Copy Number Polymorphism in the Human Genome,” Science, 305(5683): 525-528, 2004.
[53] U.S. Pat. No. 6,221,592

What is claimed is:

1. A computer-accessible medium having stored thereon computer executable instructions for assembling at least one haplotype sequence or genotype sequence of at least one genome, wherein, when the executable instructions are executed by a processing arrangement, the processing arrangement is configured to perform at least one procedure comprising:
(a) obtaining a plurality of randomly located sequence reads;
(b) incrementally creating overlap relations between the randomly located sequence reads using a plurality of overlapper procedures;
(c) generating a layout of all of or a subset of randomly located short sequence reads based on at least one score function in combination with constraints based on information associated with the at least one genome while substantially satisfying the constraints, wherein the at least one score-function is derived from overlap relations between the randomly located short sequence reads;
(d) searching together with score- and constraint-dependent pruning to determine the layout substantially satisfying the constraints; and
(e) generating at least one part of at least one genome wide haplotype sequence or at least one genotype sequence of the at least one genome based on the overlap relations and the layout of the randomly located sequence reads.

2. The computer-accessible medium of claim 1, wherein the processing arrangement is further configured to incrementally provide the overlap relations in a window-by-window manner.

3. The computer-accessible medium of claim 1, wherein the overlapper procedures include at least one of a prefix tree, a Burrows-Wheeler transform, a hashing procedure, or a sorting procedure.

4. The computer-accessible medium of claim 3, wherein the overlapper procedure includes the hashing procedure when a size of the randomly located sequence reads is less than about 100 base pairs.

5. The computer-accessible medium of claim 3, wherein the overlapper procedure includes the prefix tree when a size of the randomly located sequence reads is greater than about 200 base pairs.

6. The computer-accessible medium of claim 3, wherein the overlapper procedure includes the Burrows-Wheeler transform when an error rate in the at least one haplotype sequence or a genotype sequence is at or substantially near 0.

7. The computer-accessible medium of claim 3, wherein the overlapper procedure includes the hashing procedure when an error rate in the at least one haplotype sequence or a genotype sequence is low.

8. The computer-accessible medium of claim 1, wherein each of the randomly located sequence reads is a seed, each of the seeds having a forward direction including overlapping sequence reads in the forward direction and a backward direction including overlapping sequences in the backward direction.

9. The computer-accessible medium of claim 8, wherein the processing arrangement is further configured to:
produce multiple contigs by following different branches in the forward direction and the backward direction, each of the branches representing an instance where multiple sequence reads overlap a single sequence read; and
organize the contigs in order based on at least one predetermined organizing score.

10. The computer-accessible medium of claim 9, wherein the processing arrangement is further configured to generate the at least one predetermined organizing score for the multiple contigs using at least one score function.

11. The computer-accessible medium of claim 10, wherein the at least one score function includes at least one of PCR, microarray, dilution, optical maps, or independent reads.

12. The computer-accessible medium of claim 8, wherein the processing arrangement is further configured to parallelize assembling of at least one of the forward direction or the backward direction by passing the assembling of at least one of the forward direction or the backward direction to a further processing arrangement.

13. The computer-accessible medium of claim 1, wherein the processing arrangement is further configured to parallelize assembling of the at least one haplotype sequence or genotype sequence by passing at least one sequence read to at least one further processing arrangement.

14. The computer-accessible medium of claim 13, wherein the processing arrangement is further configured to communicate with the at least one further processing arrangement by passing information pertaining to the sequence reads to the at least one further processing arrangement using asynchronous message queues.

15. The computer-accessible medium of claim 1, wherein the information includes at least one of an estimated global position of a contig, relative position information or read information.

16. The computer-accessible medium of claim 9, wherein the processing arrangement is further configured to parallelize assembling of the branches by passing at least one of the branches to at least one further processing arrangement.

17. The computer-accessible medium of claim 9, wherein each of the randomly located sequence reads is a node, and the processing arrangement is further configured to select one branch when at least two of the branches converge at a single node, and prune further of the branches.

18. The computer-accessible medium of claim 1, wherein the randomly located sequence reads include randomly located short sequence reads.

19. The computer-accessible medium of claim 18, wherein the randomly located short sequence reads include less than about 100 base pairs.

20. The computer-accessible medium of claim 1, wherein the information includes long-range information.

21. The computer-accessible medium of claim 21, wherein the long-range information includes information that is greater than about 150 Kb.

22. The computer-accessible medium of claim 1, wherein the processing arrangement is further configured to generate the layout such that the layout is globally optimal with respect to the at least one score function.

23. The computer-accessible medium of claim 1, wherein the overlap relations include short range overlap relations.

24. The computer-accessible medium of claim 1, wherein the processing arrangement is further configured to convert a globally optimal layout into one or more consensus sequences so as to substantially satisfy the constraints.

25. A method for assembling at least one haplotype sequence or genotype sequence of at least one genome, comprising:
(a) obtaining a plurality of randomly located sequence reads;
(b) incrementally generating overlap relations between the randomly located sequence reads using a plurality of overlapper procedures;
(c) generating a layout of at least some of the randomly located short sequence reads based on at least one score function in combination with constraints based on information associated with the at least one genome while substantially satisfying the constraints, wherein the at least one score-function is derived from overlap relations between the randomly located short sequence reads;
(d) searching together with score- and constraint-dependent pruning to determine the layout substantially satisfying the constraints; and
(e) using a computer hardware arrangement, generating at least one part of at least one genome wide haplotype sequence or at least one genotype sequence of the at least one genome based on the overlap relations and the randomly located sequence reads.

26. A system for assembling at least one haplotype sequence or genotype sequence of at least one genome, comprising:
a computer hardware arrangement configured to:
(a) obtain a plurality of randomly located sequence reads;
(b) incrementally create overlap relations between the randomly located sequence reads using a plurality of overlapper procedures;
(c) generate a layout of all of or a subset of randomly located short sequence reads based on at least one score function in combination with constraints based on information associated with the at least one genome while substantially satisfying the constraints, wherein the at least one score-function is derived from overlap relations between the randomly located short sequence reads;
(d) search together with score- and constraint-dependent pruning to determine the layout substantially satisfying the constraints; and
(e) generate at least one part of at least one genome wide haplotype sequence or at least one genotype sequence of the at least one genome based on the overlap relations and the randomly located sequence reads.
